(19) United States
(12) Patent Application Publication
(10) Pub. No.: US 2017/0291548 A1
(43) Pub. Date: Oct. 12, 2017

(54) Interior Camera Apparatus, Driver Assistance Apparatus Having The Same And Vehicle Having The Same

(71) Applicant: LG ELECTRONICS INC., Seoul (KR)

(72) Inventors: Yiebin KIM, Seoul (KR); Eunhan SONG, Seoul (KR); Hoyoung LEE, Seoul (KR)

(21) Appl. No.: 15/446,065

(22) Filed: Mar. 1, 2017

Related U.S. Application Data
(60) Provisional application No. 62/319,779, filed on Apr. 7, 2016.

(30) Foreign Application Priority Data
Jun. 14, 2016 (KR) 10-2016-0074109

(51) Int. Cl. B60R 1/00; H04N 5/225; H04N 13/02

(52) U.S. Cl. CPC B60R 1/00; H04N 13/0207; H04N 13/0253; H04N 5/2252; H04N 13/0296; B60R 2300/107; B60R 2300/103; B60R 2300/8006

(57) ABSTRACT

An interior camera apparatus includes a frame body and a stereo camera provided in the frame body and including a first camera and a second camera. The interior camera apparatus also includes a light module provided in the frame body and configured to radiate infrared light; and a circuit board connected to the stereo camera and the light module. The light module includes a first light emitting element and a second light emitting element. The interior camera apparatus is configured to direct infrared light emitted from the first light emitting element in a first irradiation direction and to direct infrared light emitted from the second light emitting element in a second irradiation direction different from the first irradiation direction.

### CROSS-REFERENCE TO RELATED APPLICATIONS

This application claims the benefit of an earlier filing date and right of priority to Korean Patent Application No. 10-2016-0074109, filed on Jun. 14, 2016 in the Korean Intellectual Property Office, which claims the benefit of an earlier filing date and right of priority to U.S. Provisional Patent Application No. 62/319,779, filed on Apr. 7, 2016, the entire contents of which are incorporated herein by reference in its entirety.

### TECHNICAL FIELD

The present disclosure relates to an interior camera apparatus provided in a vehicle, a driver assistance apparatus having the same, and a vehicle having the same.

### BACKGROUND

A vehicle is an apparatus that transports a user riding therein in a desired direction. An example of a vehicle is an automobile.

A vehicle typically includes a source of power for motorizing the vehicle, and may be configured as, for example, an internal combustion engine vehicle, an external combustion engine vehicle, a gas turbine vehicle, an electric vehicle, etc. according to the type of power source implemented.

An electric vehicle is a vehicle implementing an electric motor that uses electric energy. Example of electric vehicles include a pure electric vehicle, a hybrid electric vehicle (HEV), a plug-in hybrid electric vehicle (PHEV), a fuel cell electric vehicle (FCEV), etc.

Recently, intelligent vehicles have been actively developed that are designed to improve safety or convenience of a driver in the vehicle or a pedestrian outside the vehicle.

Some intelligent vehicles implement information technology (IT) and are also referred to as smart vehicles or intelligent vehicles. Some intelligent vehicles are designed to provide improved traffic efficiency by implementing an advanced vehicle system and by coordinating with an intelligent traffic system (ITS).

In addition, research into sensor mounted in such intelligent vehicles has been actively conducted. Examples of sensors for intelligent vehicles include a camera, an infrared sensor, a radar, a global positioning system (GPS), a Lidar, a gyroscope, etc. In particular, cameras perform an important function of providing views inside or outside a vehicle where a user otherwise cannot see.

Accordingly, with development of various sensors and electronic apparatuses, a vehicle including a driver assistance function for assisting driving operations and improving driving safety and convenience is attracting considerable attention.

### SUMMARY

System and techniques are disclosed that enable a driver assistance apparatus with an interior camera apparatus.

In one aspect, an interior camera apparatus may include a frame body and a stereo camera provided in the frame body and including a first camera and a second camera. The interior camera apparatus may also include a light module provided in the frame body and configured to radiate infrared light; and a circuit board connected to the stereo camera and the light module. The light module may include a first light emitting element and a second light emitting element. The interior camera apparatus may be configured to direct infrared light emitted from the first light emitting element in a first irradiation direction and to direct infrared light emitted from the second light emitting element in a second irradiation direction different from the first irradiation direction.

In some implementations, the frame body may define a first hole in which the first camera is provided, a second hole in which the light module is provided, and a third hole in which the second camera is provided. The first hole, the second hole, and the third hole may be arranged along a common direction.

In some implementations, the first light emitting element may include a first light emitting chip and a first substrate supporting the first light emitting chip. The second light emitting element may include a second light emitting chip and a second substrate supporting the second light emitting chip. An upper surface of the first substrate may be aligned in the first irradiation direction, and an upper surface of the second substrate may be aligned in the second irradiation direction.

In some implementations, the interior camera apparatus may further include a first optical member provided on the first light emitting element and configured to distribute infrared light radiated by the first light emitting element in the first irradiation direction; and a second optical member provided on the second light emitting element and configured to distribute infrared light radiated by the second light emitting element in the second irradiation direction.

In some implementations, the first light emitting element may include a first light emitting chip and a first body that surrounds the first light emitting chip and that is configured to guide infrared light radiated by the first light emitting chip in the first irradiation direction. The second light emitting element may include a second light emitting chip and a second body that surrounds the second light emitting chip and that is configured to guide infrared light radiated by the second light emitting chip in the second irradiation direction.

In some implementations, the frame body may be a first frame body, the stereo camera may be a first stereo camera, the light module may be a first light module, and the circuit board may be a first circuit board. The interior camera apparatus may further include a second frame body, a second stereo camera, a second light module, and a second circuit board. The interior camera apparatus may further include a first interior camera module including the first frame body, the first stereo camera, the first light module, and the first circuit board; a second interior camera module including the second frame body, the second stereo camera, the second light module, and the second circuit board; and a frame cover configured to support the first interior camera module and second interior camera module.

In some implementations, the frame cover may define a first cavity configured to accommodate the first interior camera module; and a second cavity configured to accommodate the second interior camera module. The frame cover may include a bridge base configured to connect the first cavity and the second cavity.

In some implementations, the frame cover may include a first surface that defines the first cavity, the first surface further defining a first cover hole, a second cover hole, and a third cover hole. The frame cover may include a second surface that defines the second cavity, the second surface further defining a fourth cover hole, a fifth cover hole, and a sixth cover hole.

In some implementations, the first surface and the second surface of the frame cover may be symmetrical to each other around a reference line traversing the bridge base of the frame cover.

In some implementations, the interior camera apparatus may further include at least one processor provided on the circuit board and configured to control the stereo camera and the light module.

In some implementations, the at least one processor may be configured to selectively drive the first light emitting element and the second light emitting element.

In some implementations, the at least one processor may further be configured to sequentially and repeatedly perform: a first control process of controlling the first light emitting element to be in an on state and controlling the second light emitting element to be in an off state, a second control process of controlling the first light emitting element to be in an off state and controlling the second light emitting element to be in an on state, and a third control process of controlling both the first light emitting element and the second light emitting element to be in an off state.

In some implementations, the stereo camera may include a rolling shutter type camera and may be configured to sense an image. The at least one processor may be configured to perform the first control process of controlling the first light emitting element to be in the on state and controlling the second light emitting element to be in the off state in coordination with an exposure time of the stereo camera.

In some implementations, the at least one processor may further be configured to, during the first control process: control the stereo camera to sense, during the first control period, an image on a first pixel area of the stereo camera matching the first irradiation direction in which the infrared light is emitted from the first light emitting element of the light module.

In some implementations, the at least one processor may further be configured to: perform the second control process of controlling the first light emitting element to be in the off state and controlling the second light emitting element to be in the on state an based on completion of sensing the image on the first pixel area being completed, and control the stereo camera to sense, during the second control process, the image on a second pixel area matching the second irradiation direction in which the infrared light is emitted from the second light emitting element of the light module.

In some implementations, the at least one processor may further be configured to perform the third control process of controlling both the first light emitting element and the second light emitting element to be in the off state based on completion of sensing the image on the first pixel area and the second pixel area.

In some implementations, the stereo camera and the light module may be configured such that an image-sensing direction of the stereo camera corresponds to an infrared-light irradiation direction of the light module.

In some implementations, the stereo camera and the light module may be configured such that a change in the image sensing direction of the stereo camera matches a change in the infrared-light irradiation direction of the light module.

In another aspect, a driver assistance apparatus may be configured to: monitor, by the interior camera apparatus according to one or more of the implementations described above, a user entering a vehicle; acquire monitoring information based on monitoring the user entering the vehicle; and control a driver assistance function based on the monitoring information.

In another aspect, a vehicle may include the interior camera apparatus according to one or more of the implementations described above, wherein the interior camera apparatus is provided on a ceiling of the vehicle.

All or part of the features described throughout this application can be implemented as a computer program product including instructions that are stored on one or more non-transitory machine-readable storage media, and that are executable on one or more processing devices. All or part of the features described throughout this application can be implemented as an apparatus, method, or electronic system that can include one or more processing devices and memory to store executable instructions to implement the stated functions.

The details of one or more implementations are set forth in the accompanying drawings and the description below. Other features will be apparent from the description and drawings, and from the claims. The description and specific examples below are given by way of illustration only, and various changes and modifications will be apparent.

### BRIEF DESCRIPTION OF THE DRAWINGS

FIG. 1 is a diagram illustrating an example of an exploded perspective view of an interior camera apparatus including two or more interior camera modules according to some implementations;

FIG. 2 is a diagram showing an example appearance of an interior camera module according to some implementations;

FIG. 3 is a diagram illustrating an example of a cross-sectional view taken along line A-A′ of FIG. 2;

FIG. 4 is a diagram showing an example of a cross-section of a light emitting element according to some implementations;

FIG. 5 is a diagram showing an example appearance of a light module according to some implementations;

FIG. 6A is a diagram showing an example appearance of a light module according to another implementation;

FIG. 6B is a diagram illustrating an example of a plan view of an optical member according to another implementation;

FIGS. 7A and 7B are diagrams showing examples of a comparison in optical properties according to body shape of a light emitting element;

FIG. 7C is a graph showing an example distribution of light emitted from light emitting elements;

FIG. 8 is a diagram illustrating an example of a cross-sectional view of a light module according to another implementation;

FIG. 9 is a diagram schematically showing an example of an interior camera apparatus according to some implementations;

FIG. 10 is a diagram showing an example of a state of operating a light module according to some implementations;

FIG. 11 is a diagram illustrating an example operation of an image sensor of a camera according to some implementations;

FIG. 12 is a diagram showing Example 1 of a method of driving an interior camera apparatus;

FIG. 13 is a diagram showing Example 2 of a method of driving an interior camera apparatus;

FIG. 14A is a diagram showing an example of an image obtained by capturing a wall, onto which light is radiated, in Example 1, and FIG. 14B is a graph showing an example distribution of light radiated onto the wall;

FIG. 15A is a diagram showing an example of an image obtained by capturing and combining a wall, onto which light is radiated, at two points of time in Example 2 and FIG. 15B is a graph showing an example distribution of light radiated onto the wall;

FIG. 16 is a diagram showing an example appearance of a vehicle including an interior camera apparatus according to some implementations;

FIG. 17 is a diagram showing an example of the inside of a vehicle including an interior camera apparatus according to some implementations;

FIG. 18 is a block diagram showing an example of a driver assistance apparatus including an interior camera according to some implementation;

FIGS. 19 and 20 are diagrams illustrating examples of processing an interior camera image and acquiring image information according to some implementations;

FIGS. 21A to 21C are diagrams showing examples of gestures recognized through an interior camera according to some implementations;

FIG. 22 is a diagram illustrating an example of vehicle function control according to change in gesture input position according to some implementations;

FIG. 23 is a diagram illustrating an example of controlling functions through gesture input at a specific position according to some implementations;

FIG. 24 is a diagram showing an example of a state in which an interior camera specifies a concentrated monitoring area according to some implementations;

FIGS. 25A and 25B are diagrams illustrating examples of changes in gesture graphical user interface according to change in vehicle traveling state according to some implementations;

FIGS. 26A and 26B are diagrams illustrating examples of change in concentrated monitoring area according to change in vehicle traveling state according to some implementations;

FIGS. 27A and 27B are diagrams illustrating examples of change in graphical user interface according to the number of icons according to some implementations;

FIG. 28 is a diagram illustrating an example of gesture control rights according to the position of a vehicle according to some implementations; and

FIG. 29 is a block diagram showing an example of the internal configuration of the vehicle of FIG. 16 including the interior camera.

### DETAILED DESCRIPTION

Systems and techniques are disclosed herein that provide an interior camera apparatus of a vehicle that coordinates selective emission of light from a light module with capturing of images by an image capturing device. By selectively emitting light in only specific directions and at specific times based on the operations of the image capturing device, the apparatus may help reduce heat generation and improve efficiency while maintaining proper image capturing functionality.

In some scenarios, a driver state monitoring (DSM) system is configured to sense a state of a driver of a vehicle, such as eye-blink or facial direction of the driver, to aid in safe driving.

As an example, a DSM system may be configured to help prevent sleepiness of a driver. A DSM system may utilize technology for detecting facial expressions and emotional states of a driver, and generating a warning when possibility of a vehicular accident is determined to be high.

However, in scenarios in which a single camera is used as a camera for a DSM system, information acquired by a two-dimensional (2D) image captured by the single camera may be inaccurate, such that it is difficult to detect various states of a driver or detect complex situations in a vehicle.

Some DSM systems utilizes infrared light to capture an image of an interior of a vehicle without obstructing the driver's field of vision. However, in such scenarios, heat generated by an illumination for emitting infrared light may inhibit image sensing.

Systems and techniques disclosed herein provide an interior camera apparatus that coordinates operations of a light module and a stereo camera to enable a low-heat light module that facilitates acquiring a three-dimensional (3D) image.

The interior camera according to some implementations includes a light module which can be driven with low power and low heat and a stereo camera capable of sensing a 3D space.

In detail, the light module may include a plurality of light emitting elements having different irradiation directions. Such a light module can efficiently radiate infrared light to aid in sensing a high-quality image with low power and low heat.

In addition, the stereo camera can sense a high-quality image by the aid of the light module and measure distance from a captured object.

In addition, since the stereo camera is of a rolling shutter type and has a high image scan speed (frame rate), the stereo camera can be suitably used for a vehicular imaging apparatus such as a driver state monitoring (DSM) system.

In addition, an interior camera according to an embodiment includes two interior cameras provided in a symmetrical structure to simultaneously monitor a driver seat and a passenger seat upon being mounted in a vehicle.

The interior camera can change an irradiation area of a light module to specify a monitoring area.

A driver assistance apparatus according to an embodiment can provide various user interfaces capable of improving user convenience and stability using such an interior camera.

In particular, the driver assistance apparatus can provide a graphical user interface varying according to a vehicle traveling state and provide a graphical user interface varying according to a driver assistance function control element, thereby increasing user convenience.

A vehicle according to an embodiment includes such an interior camera provided on a ceiling of a vehicle to efficiently and divisionally monitor the overall area of the vehicle.

A vehicle as described in this specification may include any suitable type of vehicle, such as a car or a motorcycle. The description hereinafter presents examples based on a car.

A vehicle as described in this specification may be powered by any suitable source and may be an internal combustion engine vehicle including an engine as a power source, a hybrid vehicle including both an engine and an electric motor as a power source, an electric vehicle including an electric motor as a power source, or any suitably powered vehicle.

In the following description, the left of a vehicle refers to the left-hand side of the vehicle in the direction of travel and the right of the vehicle refers to the right-hand of the vehicle in the direction of travel.

In the following description, a left hand drive (LHD) vehicle will be focused upon unless otherwise stated.

In the following description, the driver assistance apparatus is provided in a vehicle to exchange information utilized for data communication with the vehicle and to perform a driver assistance function. A set of some units of the vehicle may be defined as a driver assistance apparatus.

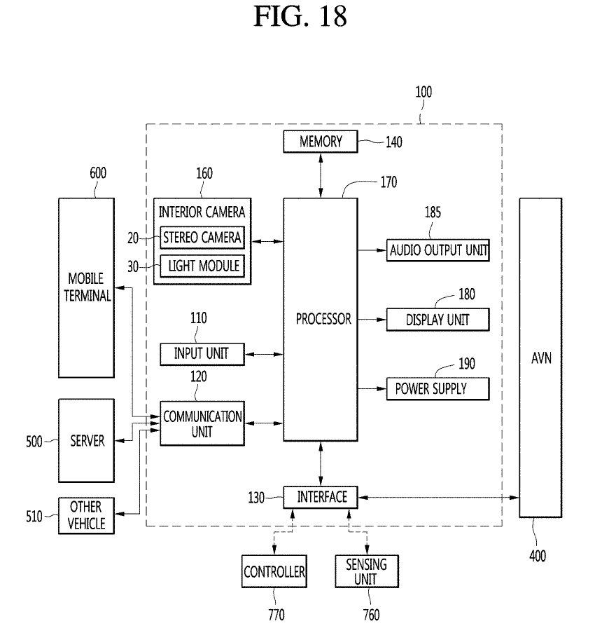

When the driver assistance apparatus is separately provided, at least some units (see FIG. 18) of the driver assistance apparatus are not included in the driver assistance apparatus but may be units of the vehicle or units of another apparatus mounted in the vehicle. Such external units transmit and receive data via an interface of the driver assistance apparatus and thus may be understood as being included in the driver assistance apparatus.

Hereinafter, for convenience of description, assume that the driver assistance apparatus according to the embodiment directly includes the units shown in FIG. 18.

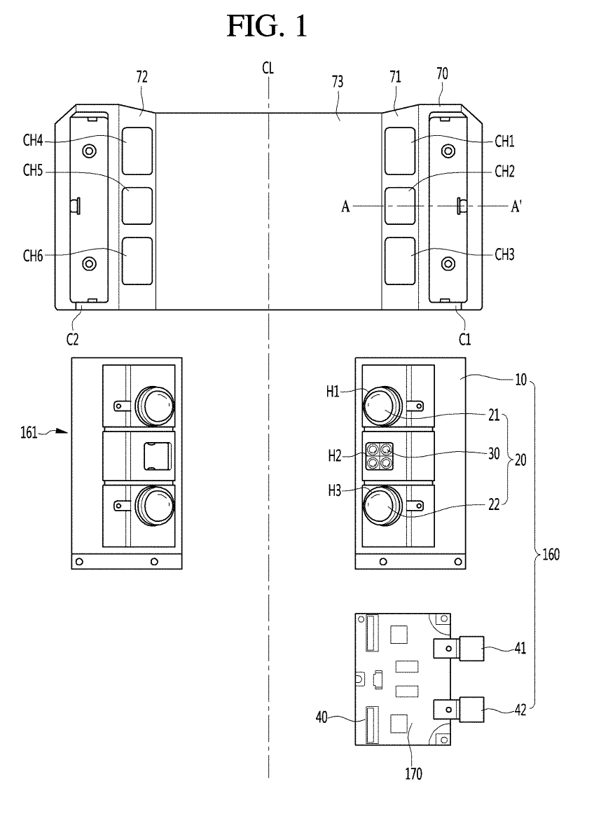

Hereinafter, an interior camera apparatus will be described in detail with reference to FIGS. 1 to 15.

Referring to FIG. 1, an example interior camera apparatus according to an embodiment may include a frame cover 70, a first interior camera module 160 and a second interior camera module 161.

In detail, the first interior camera module 160 may capture an image in one direction and the second interior camera module 161 may capture an image in another direction different from the capturing direction of the first camera module.

The frame cover 70 may simultaneously support the first interior camera module 160 and the second interior camera module 161.

Prior to the description of the overall structure of the complex interior camera module, the detailed configuration of the interior camera module will be described.

In some implementations, the first interior camera module 160 and the second interior camera module 161 are equal in configuration but are different in capturing direction according to arrangement of the frame cover 70. Thus, the description of the interior camera module is commonly applicable to the first interior camera module 160 and the second interior camera module 161.

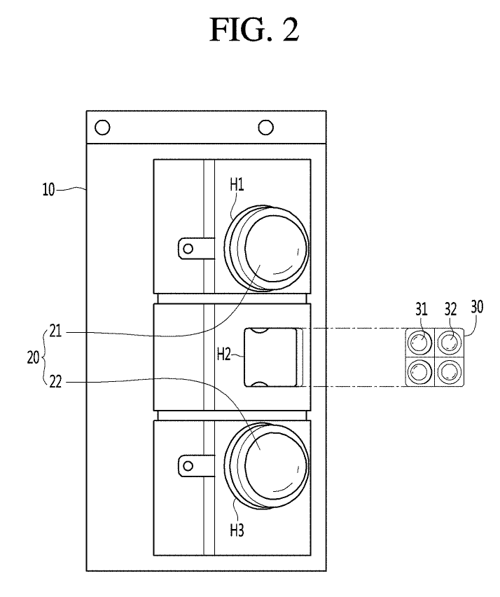

Referring to FIGS. 1 and 2, the interior camera module 160 according to the embodiment may include a frame body 10, a stereo camera 20 provided in the frame body 10 and including a first camera 21 and a second camera 22, a light module 30 provided in the frame body 10 to radiate infrared light, and a circuit board 40 connected to the stereo camera 20 and the light module 30. In particular, the light module 30 may include at least two light emitting elements 31 and 32 having different irradiation directions.

First, the frame body 10 may have a space for accommodating the first camera 21, the second camera 22 and the light module 30.

In detail, the frame body 10 has a space, one side of which is opened, such that the first camera 21, the second camera 22 and the light module 30 may be mounted therein through the opened space. The circuit board 40 is provided in the opened area of the frame body 10 to be electrically connected to the stereo camera 20 and the light module 30.

In one surface of the frame body 10, a first hole H1, a second hole H2 and a third hole H3 may be arranged in one direction. Accordingly, the alignment direction of the hole may extend in a perpendicular direction of one surface of the frame body 10.

At least a portion of the first camera 21 may be provided in the first hole H1 of the frame body 10, the light module 30 may be provided in the second hole H2 and at least a portion of the second camera 22 may be provided in the third hole H3. That is, the light module 30 may be disposed between the first camera 21 and the second camera 22.

Accordingly, the light module 30 disposed between the first camera 21 and the second camera 22 may equally radiate infrared light to an area captured by the first camera 21 and an area captured by the second camera 22.

The first camera 21 and the second camera 22 may configure the stereo camera 20 for capturing an image and measuring a distance from an object included in the captured image.

In some implementations, the stereo camera 20 may be a rolling shutter type and may sense an image using lines of pixels that are implemented by the stereo camera. In detail, the stereo camera 20 may implement a plurality of pixel lines for sensing an image and may sense the image by sequentially utilizing the lines of pixels.

For example, if stereo camera 20 implements pixel lines arranged along a row in a horizontal direction, then the stereo camera 20 may scan an image by sequentially utilizing lines of pixels, starting from a first pixel line at an uppermost row of the lines of pixels, and ending with a last pixel line at the bottommost row of the lines of pixels.

The rolling shutter type stereo camera 20 has a high image scan speed (frame rate) and is suitably used for a vehicular imaging apparatus such as a DSM system.

The light module 30 may include at least two light emitting elements having different irradiation directions.

In an embodiment, the light module 30 may include a first light emitting element 31 that is utilized to radiate infrared light in a first irradiation direction and a second light emitting element 32 that is utilized to radiate infrared light in a second irradiation direction different from the first irradiation direction. Here, the irradiation direction is defined as a central direction of a distribution of light radiated by the light emitting element.

Referring to FIG. 2, although two light emitting element groups having the same irradiation direction are shown as the first light emitting element 31 and two light emitting element groups having the same irradiation direction are shown as the second light emitting element 32, the description of the first light emitting element 31 and the second light emitting element 32 may be understood as being applicable to both light emitting elements.

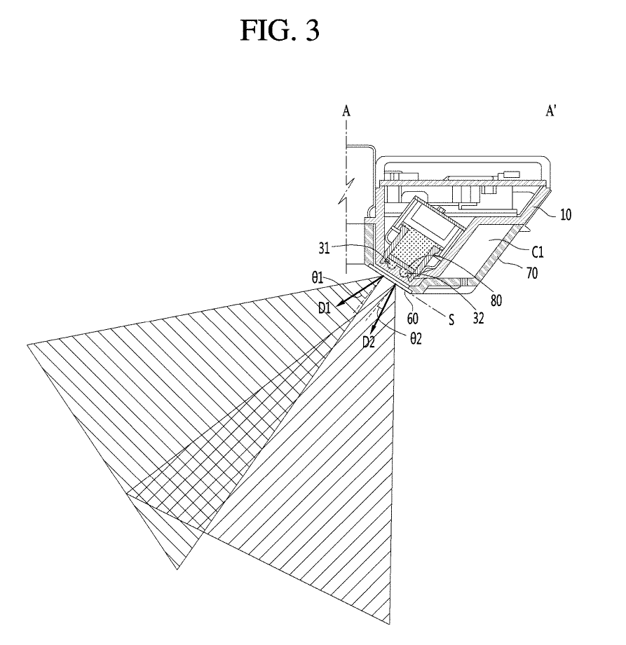

Referring to FIG. 3, it can be seen that the light irradiation direction of the first light emitting element 31 and the light irradiation direction of the second light irradiation element 32 are different. Accordingly, the light irradiation area of the first light emitting element 31 and the light irradiation area of the second light irradiation element 32 are different. That is, the light module 30 includes two or more light emitting elements having different irradiation directions to radiate light to a wide area.

For example, the first irradiation direction D1 of the first light emitting element 31 may be a direction tilted from a perpendicular direction of an upper surface of an optical member, through which infrared light finally passes, by a predetermined angle θ1 (90 degrees or less) in a first direction.

The second irradiation direction D2 of the second light emitting element 32 may be a direction tilted from the perpendicular direction of the upper surface of the optical member 60 by a predetermined angle θ2 (90 degrees or less) in a second direction opposite to the first direction.

Accordingly, some of the light irradiation area of the first light emitting element 31 and the light irradiation area of the second light emitting element 32 may overlap. For example, when light radiated by the first light emitting element 31 covers the upper area of a wall, light radiated by the second light emitting element 32 covers the lower area of the wall, and lights may overlap in the middle area of the wall.

By implementing light emitting elements having different irradiation directions, the light module 30 may, in some implementations, selectively utilize different light emitting elements to only radiate light to specific areas at specific times, rather than radiating light to all areas. As such, this selective radiation may improve light emission efficiency and reduce heat generated by the light module 30.

As an example, the light module 30 may turn of all of the light emitting elements during times when the stereo camera 20 does not sense an image, and the light module 30 may selectively turn on some of the light emitting elements only when the stereo camera is sensing an image. This coordinated control between selective radiation by light module 30 and image capturing by stereo camera 20 may help drive the interior camera apparatus with less power consumption and less heat generation.

As an example of coordinated control between light module 30 and stereo camera 20, in the case of the stereo camera 20 being a rolling shutter type stereo camera described above, the light module 30 may be configured to selectively radiate in directions that correspond to sequential scanning by the pixels of the rolling shutter type stereo camera. In particular, a if the stereo camera 20 is a rolling shutter type stereo camera, then the camera performs image sensing by sequentially utilizing lines of pixels. In such scenarios, the area of the image being sensed by the stereo camera 20 changes in a sequential manner. To coordinate the light module 30 with this sequential scanning, the light module 30 may be configured to dynamically and selectively activate those light emitting elements that correspond to the image sensing area of the rolling shutter type camera. Such coordination between light module 30 and stereo camera 20 may help reduce consumption of power while maintaining image capture performance by dynamically and selectively activating only those light emitting elements that are relevant to the image capturing operation.

As a specific example, when the stereo camera 20 captures a portion of an image using one area of pixels, if image sensing is sequentially performed from an upper side of the pixel area to a lower side of the pixel area, then the light module 30 may turn on only the first light emitting element 31 to radiate light toward the upper side when image sensing is performed with respect to the upper area and turn on only the second light emitting element 32 to radiate light toward the lower side when image sensing is performed with respect to the lower area, thereby radiating light to the captured area with power which is half the power consumed when both light emitting elements operate.

Since the stereo camera 20 may capture only the light irradiation area, the light module 30 may radiate light to an area where image sensing is to be performed, thereby restricting an area captured by the stereo camera 20, that is, a monitoring area.

Hereinafter, prior to description of the overall structure of the light module 30, an example of a single light emitting element configuring the light module 30 will be described in detail.

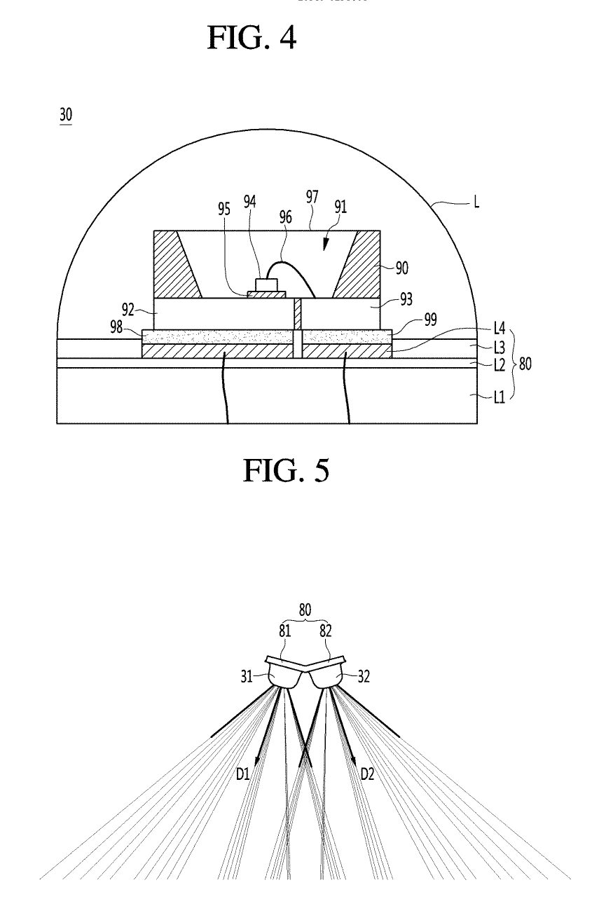

Referring to FIG. 4, the light emitting element may include a body 90, a plurality of electrodes 92 and 93, a light emitting chip 94, a bonding member 95 and a molding member 97.

The body 90 may be made of a material selected from among an insulating material, a transparent material and a conductive material. For example, the body may be formed of at least one of resin such as polyphthalamide (PPA), silicon (Si), metal, photo sensitive glass (PSG), sapphire (Al₂O₃), silicon, epoxy molding compound (EMC) and a polymer-series or plastic-series printed circuit board (PCB) 40. For example, the body 90 may be formed of a material selected from among resin such as polyphthalamide (PPA), silicon or epoxy. The shape of the body 90 may include a polygon, a circle or a shape having a curved surface when viewed from above, without being limited thereto.

The body 90 may include a cavity 91, the upper side of the cavity 91 is opened, and the circumference of the cavity has an inclined surface. The plurality of electrodes 92 and 93 may be formed below the cavity 91. For example, two or more electrodes may be formed. The plurality of electrodes 92 and 93 may be spaced apart from each other on the bottom of the cavity 91. The width of the lower side of the cavity 91 may be greater than that of the upper side of the cavity, without being limited thereto.

The electrodes 92 and 93 may include a metal material, for example, at least one of titanium (Ti), copper (Cu), Nickel (Ni), gold (Au), chrome (Cr), tantalum (Ta), platinum (Pt), tin (Sn), silver (Ag) and phosphorous (P) and may be formed of a single metal layer or multiple metal layers.

An insulating material may be formed in a gap between the plurality of electrodes 92 and 93. The insulating material may be equal to or different from the material of the body 50, without being limited thereto.

The light emitting chip 94 may be provided on at least one of the plurality of electrodes 92 and 93 and may be bonded by the bonding member 95 or through flip chip bonding. The bonding member 95 may be a conductive paste material including silver Ag.

The plurality of electrodes 92 and 93 may be electrically connected to the pads P1 and P2 of a wiring layer L1 of a substrate 80 through binding members 98 and 99.

The light emitting chip 94 may selectively emit light in a range from a visible band to an infrared band. The light emitting chip 94 may include a compound semiconductor of III-V group elements and/or II-VI group elements. Although the light emitting chip 94 is provided in a chip structure having a horizontal electrode structure, the light emitting chip may be provided in a chip structure having a vertical electrode structure in which two electrodes are arranged in a vertical direction. The light emitting chip 94 is electrically connected to the plurality of electrodes 92 and 93 by an electrical connection member such as a wire 96.

The light emitting element may include one or two or more light emitting chips, without being limited thereto. One or more light emitting chips 94 may be provided in the cavity 91 and two or more light emitting chips may be connected in series or in parallel, without being limited thereto.

The molding member 97 made of a resin material may be formed in the cavity 91. The molding member 97 includes a transparent material such as silicon or epoxy and may be formed of a single layer or multiple layers. An upper surface of the molding member 97 may include at least one of a flat shape, a concave shape or a convex shape. For example, the surface of the molding member 97 may be formed of a curved surface such as a concave surface or a convex surface and such a curved surface may become a light emitting surface of the light emitting chip 94.

The molding member 97 may include a phosphor for converting the wavelength of light emitted onto the light emitting chip 94 in a transparent resin material such as silicon or epoxy. The phosphor may be selected from among YAG, TAG, silicate, nitride and oxy-nitride materials. The phosphor may include at least one of a red phosphor, a yellow phosphor and a green phosphor, without being limited thereto. The molding member 97 may not have a phosphor, without being limited thereto.

An optical lens L may be formed on the molding member 97 and the optical lens may be made of a transparent material having a refractive index of 1.4 to 1.7. In addition, the optical lens may be formed of a transparent resin material of polymethyl methacrylate (PMMA) having a refractive index of 1.49, polycarbonate (PC) having a refractive index of 1.59, a transparent resin material of epoxy resin (EP) or transparent glass.

Hereinafter, examples of the structure of the light module 30 including at least two light emitting elements and capable of changing the irradiation direction will be described.

First, referring to FIG. 5, in the light module 30 according to a first embodiment, the first light emitting element 31 and the second light emitting element 32 may differ in irradiation direction, by varying alignment directions thereof.

In detail, the upper surface of the first substrate 81 supporting the first light emitting element 31 is aligned in a first irradiation direction D1 and the upper surface of the second substrate 82 supporting the second light emitting element 32 is aligned in a second irradiation direction D2, such that the first light emitting element 31 and the second light emitting element 32 differ in irradiation direction.

In more detail, the first light emitting element 31 includes a first light emitting chip and a first substrate 81 supporting the first light emitting chip, the second light emitting element 32 includes a second light emitting chip and a second substrate supporting the second light emitting chip, the upper surface of the first substrate 81 is aligned in the first irradiation direction D1, and the upper surface of the second substrate 82 is aligned in the second irradiation direction D2.

That is, since the first light emitting element 31 laid on the upper surface of the first substrate 81 mainly radiates infrared light in a perpendicular direction of the upper surface of the first substrate 81, the irradiation direction of light emitted from the first light emitting element 31 may be determined by varying the alignment direction of the first substrate 81.

Similarly, since the second light emitting element 32 laid on the upper surface of the second substrate mainly radiates infrared light in a perpendicular direction of the upper surface of the second substrate 82, the irradiation direction of light emitted from the second light emitting element 32 may be determined by varying the alignment direction of the second substrate 82.

In some implementations, the first substrate 81 and the second substrate 82 may be separated from each other or may be integrally formed and bent.

In detail, an angle between the first substrate 81 and the second substrate 82 may be 180 degrees or less. If the first substrate 81 and the second substrate 82 are integrally formed, an area of the first substrate 81 may extend in one direction, an area of the second substrate 82 may extend in another direction, and a portion therebetween is bent.

The light module 30 according to the first embodiment has a simple structure in which only the alignment direction of the substrate is varied such that the plurality of light emitting elements can easily radiate light in different irradiation directions.

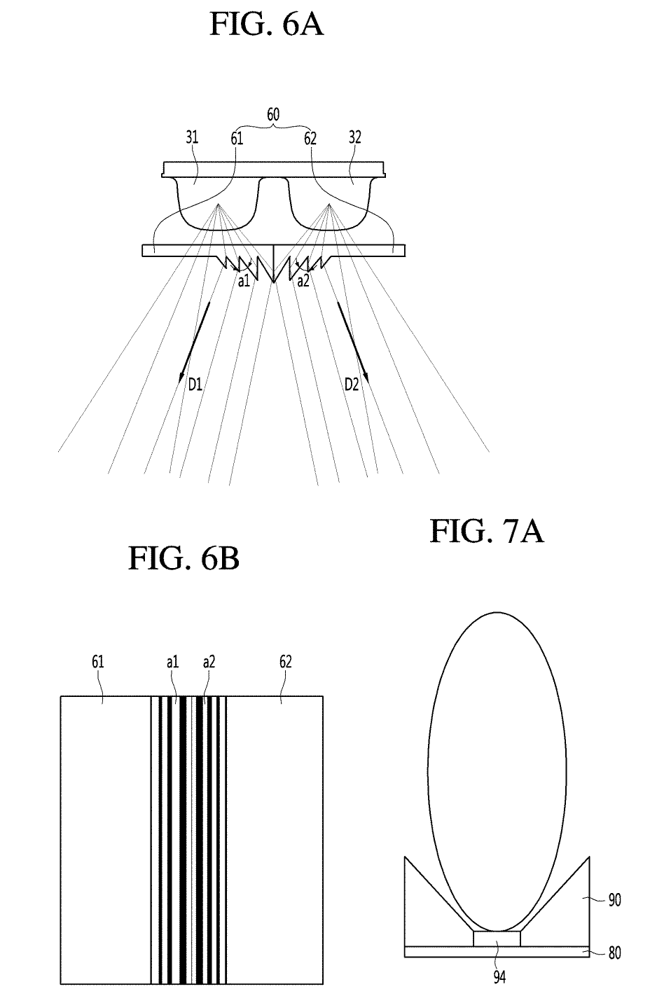

Referring to FIGS. 6A and 6B, a light module 30 according to a second embodiment may include a first light emitting element 31, a second light emitting element 32, a substrate 80 simultaneously supporting the first light emitting element 31 and the second light emitting diode 32, and an optical member 60 provided on the first light emitting element 31 and the second light emitting element 32.

In detail, the light module 30 may further include a first optical member 61 provided on the first light emitting element 31 to distribute infrared light radiated by the first light emitting element 31 in the first irradiation direction D1 and a second optical member 62 provided on the second light emitting element 32 to distribute infrared light radiated by the second light emitting element 32 in the second irradiation direction D2.

In greater detail, the first light emitting element 31 and the second light emitting element 32 may be provided side by side on the substrate. The optical member 60, through which light generated by the light emitting element passes, may be provided on the first light emitting element 31 and the second light emitting element 32. In some implementations, the optical member may include a first optical member 61 overlapping the first light emitting element 31 and a second optical member 62 overlapping the second light emitting element 32.

The first optical member 61 may include a first uneven part a1 for distributing light passing therethrough to distribute light generated by the first light emitting element 31 in the first irradiation direction D1. Similarly, the second optical member 62 may include a second uneven part a2, which is provided on the second light emitting element 32 to distribute light passing therethrough, to distribute light generated by the second light emitting element 32 in the second irradiation direction D2.

In the embodiment, the first optical member 61 and the second optical member 62 may be Fresnel lenses. The first optical member 61 may have the first uneven part only in an area contacting the second optical member 62 and a concave part of the first uneven part may be aligned in the second irradiation direction D2. In contrast, the second optical member 62 may have the second uneven part only in an area contacting the first optical member 61 and a concave part of the second uneven part may be aligned in the first irradiation direction D1.

Through such a structure, light radiated by the first light emitting element 31 passes through the first optical member 61 to be distributed in the first irradiation direction D1. Similarly, light radiated by the second light emitting element 32 passes through the second optical member 62 to be distributed in the second irradiation direction D2.

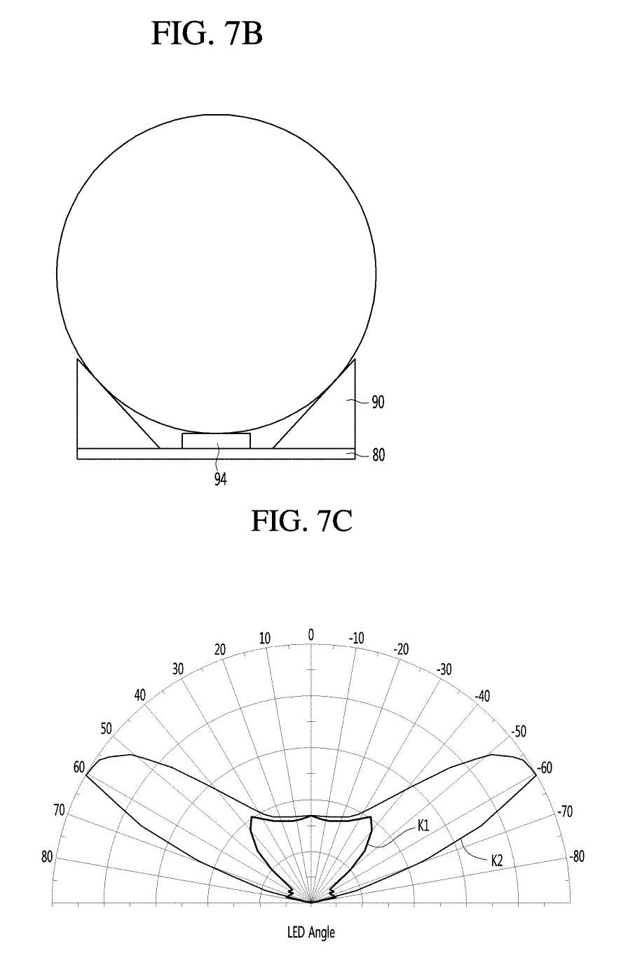

Lastly, the structure of a light module 30 according to a third embodiment will be described with reference to FIGS. 7A to 7C and 8.

First, referring to FIGS. 7A and 7B, it can be seen that the irradiation angle of light is changed according to a body 90 surrounding the light emitting chip 94.

Since light is guided along the side of the body 90 surrounding the light emitting chip 94, when the side of the body 90 is steeply inclined next to the light emitting chip 94, it is possible to intensively radiate light to a narrow area along the side of the body 90.

In contrast, when the side of the body 90 is gently inclined at a predetermined distance from the light emitting chip 94, since light is sufficiently distributed and then guided along the side of the body 90, it is possible to radiate light to a wide area along the side of the body 90.

In greater detail, referring to FIG. 7C, a graph K1 shows an angle of light when the light emitting element of FIG. 7A radiates light and a graph K2 shows an angle of light when the light emitting element of FIG. 7B radiates light.

The light module 30 according to the third embodiment may include a plurality of light emitting elements that are utilized to radiate light in different irradiation directions using the principle of changing the irradiation direction of light according to change in shape of the body 90.

In detail, referring to FIG. 8, the light module 30 may include a substrate, a first light emitting chip 94a, a first body 90a surrounding the first light emitting chip 94a, a second light emitting chip 94b and a second body 90b surrounding the second light emitting chip 94b.

In an embodiment, the first body 90a may have a structure for guiding light radiated by the first light emitting chip 94a in the first irradiation direction D1.

In greater detail, in a cross-sectional view, the first body 90a may include a first side surface LS1 inclined at one side of the first light emitting chip 94a (e.g., the side of the first irradiation direction D1) and a second side surface RS1 inclined at the other side of the first light emitting chip 94a. Light radiated by the first light emitting chip 94a may be guided along the first side surface LS1 and the second side surface RS1. Accordingly, when the first side surface LS1 is gently inclined and the second side surface RS1 is steeply inclined, light radiated by the first light emitting chip 94a may be radiated toward the first side surface LS1. Accordingly, through such a structure, the first light emitting element 31 may radiate light in the first irradiation direction D1.

In contrast, the second body 90b may have a structure for guiding light radiated by the second light emitting chip 94b in the second irradiation direction D2.

In greater detail, in a cross-sectional view, the second body 90b may include a third side surface RS2 inclined at one side of the second light emitting chip 94b (e.g., the side of the second irradiation direction D2) and a fourth side surface LS2 inclined at the other side of the second light emitting chip 94b. Light radiated by the second light emitting chip 94b may be guided along the third side surface RS2 and the fourth side surface LS2. Accordingly, when the third side surface RS2 is gently inclined and the fourth side surface LS2 is gently inclined, light radiated by the second light emitting chip 94b may be radiated toward the fourth side surface LS2.

Accordingly, through such a structure, the second light emitting element 32 may radiate light in the second irradiation direction D2.

That is, in the light module 30 according to the third embodiment, the irradiation directions of the light emitting elements may vary by varying the shape of the body 90 of each light emitting element.

In summary, in the interior camera module 160, the first camera 21 and the second camera 22 may configure the stereo camera 20, the light module 30 may be disposed between the first camera 21 and the second camera 22, and the light module 30 may include the plurality of light emitting elements having different irradiation directions. Such a light module 30 may efficiently radiate infrared light to aid in sensing a high-quality image with low power and low heat and the stereo camera 20 may sense a high-quality image and measure a distance from a captured object by the aid of the light module 30.

Returning to FIG. 1, the complex interior camera apparatus according to the embodiment may include at least two interior camera modules.

In detail, the complex interior camera apparatus may include first and second interior camera modules 160 and 161 each including a frame body (e.g., frame body 10), a stereo camera (e.g., stereo camera 20), a light module (e.g., light module 30), and a circuit board. The complex interior camera apparatus may also include a frame cover 70 supporting the first and second interior camera modules 160 and 161.

First, the frame cover 70 may include a first cavity C1 for accommodating the first interior camera module 160, a second cavity C2 for accommodating the second interior camera module 161 and a bridge base 73 for connecting the first cavity C1, the second cavity C2, and the first cavity C1 and the second cavity C2.

That is, the frame cover 70 includes cavities at both ends thereof, the first interior camera module 160 is provided at one end thereof, the second interior camera module 161 is provided at the other end thereof, and the bridge base 73 for connecting the cavities is formed between the cavities.

In detail, the frame cover 70 is bent at least twice to form the first cavity C1 and is bent at least twice to form the second cavity C2 and has the bridge base 73 for connecting a body configuring the first cavity C1 and a body configuring the second cavity C2.

One or more cover holes may be defined in the frame cover 70 such that the cover holes overlap with the cameras and light modules when an interior camera module is provided on the frame cover 70. In the example of FIG. 1, a first cover hole CH1, a second cover hole CH2 and a third cover hole CH3 are defined in a first surface 71 of the frame cover 70 configuring the first cavity C1. Similarly, a fourth cover hole CH4, a fifth cover hole CH5 and a sixth cover hole CH6 are defined in a second surface 72 of the frame cover 70 configuring the second cavity C2.

When the first interior camera module 160 is provided in the first cavity C1, the first cover hole CH1, the second cover hole CH2 and the third cover hole CH3 may overlap the first camera 21, the light module 30 and the second camera 22 of the first interior camera module 160, respectively.

Similarly, when the second interior camera module 161 is provided in the second cavity C2, the fourth cover hole CH4, the fifth cover hole CH5 and the sixth cover hole CH6 may overlap the first camera 21, the light module 30 and the second camera 22 of the second interior camera module 161, respectively.

The first surface 71 and second surface 72 of the frame cover 70 may be symmetrical to each other with respect to a reference line CL traversing the bridge base 73. Accordingly, the captured areas of the first interior camera module 160 aligned along the first surface 71 and the second interior camera module 161 aligned along the second surface 72 may be opposite to each other.

For example, when the complex interior camera apparatus is provided on the ceiling of the vehicle, the first interior camera module 160 may capture a passenger seat and the second interior camera module 161 may capture a driver seat.

That is, the complex interior camera apparatus may respectively capture and monitor the driver seat and the passenger seat when mounted in the vehicle.

Hereinafter, a method of controlling the interior camera module 160 will be described in greater detail.

A processor 170 for controlling the stereo camera 20 and the light module 30 may be provided on the circuit board 40 of the interior camera module 160.

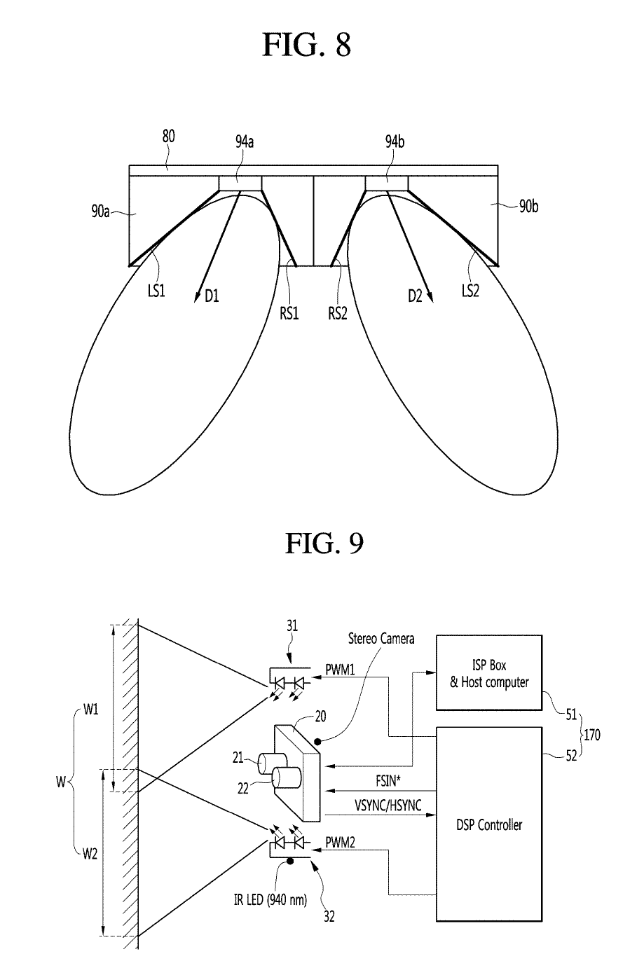

As shown in FIG. 9, although a DSP controller 52 for controlling the light module 30 and a host computer 51 for controlling the stereo camera 20 may be separate processors 170, for convenience of description, hereinafter, it is assumed that the processor 170 performs overall control.

First, the processor 170 may selectively drive the first and second light emitting elements 31 and 32 of the light module 30 to control the irradiation direction of the light module 30.

In detail, the processor 170 performs control to turn the first light emitting element 31 on and turn the second light emitting element 32 off, thereby radiating light in the first irradiation direction D1. Accordingly, it is possible to radiate light to only a first area W1 of a subject W.

In contrast, the processor 170 performs control to turn the second light emitting element 32 on and turn the first light emitting element 31 off, thereby radiating light in the second irradiation direction D2. Accordingly, it is possible to radiate light to only a second area W2 of a subject W.

Of course, the processor 170 may perform control to turn the two light emitting elements on or off.

In an embodiment, the processor 170 may sequentially and repeatedly perform a first control process of turning the first light emitting element 31 on and turning the second light emitting element 32 off, a second control process of turning the first light emitting element 31 off and turning the second light emitting element 32 on, and a third control process of turning the first and second light emitting elements 31 and 32 off.

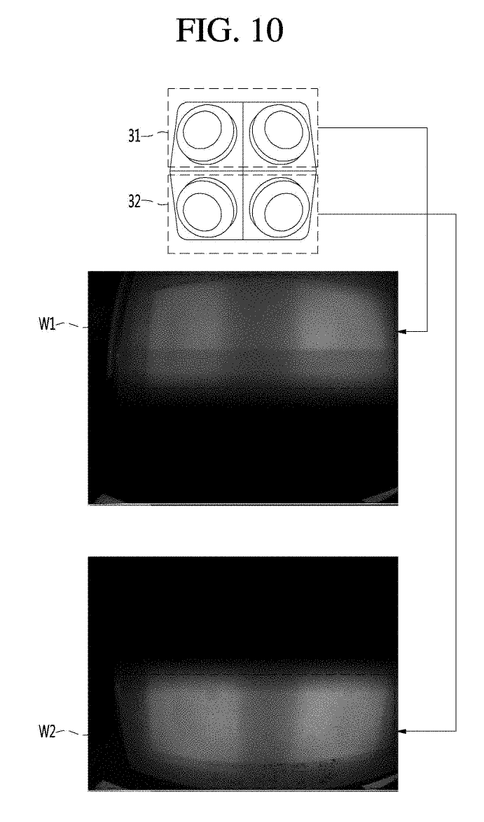

Accordingly, referring to FIG. 10, the first light emitting element 31 may radiate light in the first irradiation direction D1 to radiate light to only the first area W1 of the subject W in the first control process and radiate light in the second irradiation direction D2 to radiate light to only the second area W2 of the subject W in the second control process. In the third control process, light may not be radiated.

That is, the light module 30 may repeatedly perform a process of radiating light in the first irradiation direction D1, radiating light in the second irradiation direction D2 and not radiating light.

The stereo camera 20 may be of a rolling shutter type and may sense an image. In detail, the stereo camera 20 may include a plurality of pixel lines for sensing an image and sequentially sense the image on a per pixel line basis.

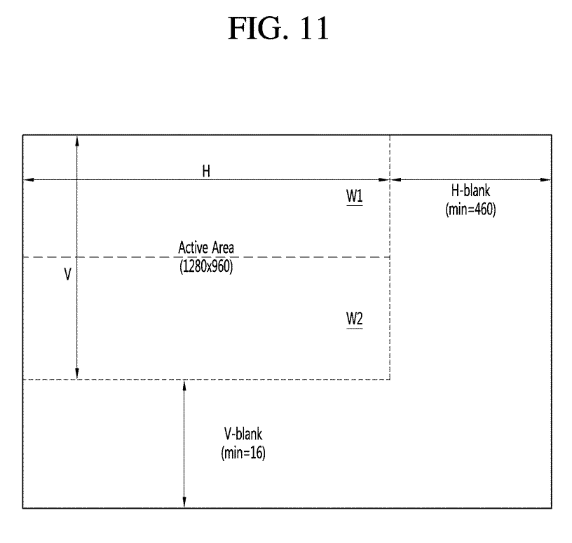

FIG. 11 shows the concept that the processor 170 controls the stereo camera 20. In detail, in an image sensing process, an image may include a plurality of pixel lines that are divided into an active area in which an image is sensed and a blank area in which an image is not sensed.

In the active area, the pixel lines extend in a horizontal direction and the plurality of pixel lines may be arranged in a vertical direction. Accordingly, when the processor 170 sequentially scans the image from a first line, which is an uppermost line, to a last line of the plurality of pixel lines, the image may be regarded as being sequentially sensed from the upper side to lower side of the captured area.

That is, the processor 170 may perform control to capture the upper side to the lower side of the captured area at a line exposure time of the stereo camera 20. Therefore, the light module 30 may radiate light to only the captured area and may not radiate light to other areas, thereby improving light efficiency.

In another aspect, the upper pixel lines of the image sensor of the stereo camera 20, that is, a first pixel area W1, may be an area in which the upper image of the subject W is sensed and the lower pixel lines of the image sensor, that is, a second pixel area W2 may be an area in which the lower image of the subject W is sensed.

The capturing direction of the stereo camera 20 and the infrared-light irradiation direction of the light module 30 may be identical. That is, the area captured by the stereo camera 20 may be equal to the area to which the light module 30 radiates infrared light.

In addition, change in the image sensing direction of the stereo camera 20 and change in the infrared-light irradiation direction of the light module 30 may match each other.

In detail, the processor 170 may control the stereo camera 20 to sense the image in the first pixel area W1 and control the light module 30 to radiate light to an upper area of the captured area and not to radiate light to the remaining area. That is, in the light module 30, the first light emitting element 31 may be turned on and the second light emitting element 32 may be turned off.

Next, the processor 170 may control the stereo camera 20 to sense the image in the second pixel area W2 and control the light module 30 to radiate light to a lower area of the captured area. That is, in the light module 30, the second light emitting element 32 may be turned on and the first light emitting element 31 may be turned off.

Next, the processor 170 may turn both the light emitting elements off not to radiate light, while the captured image is processed.

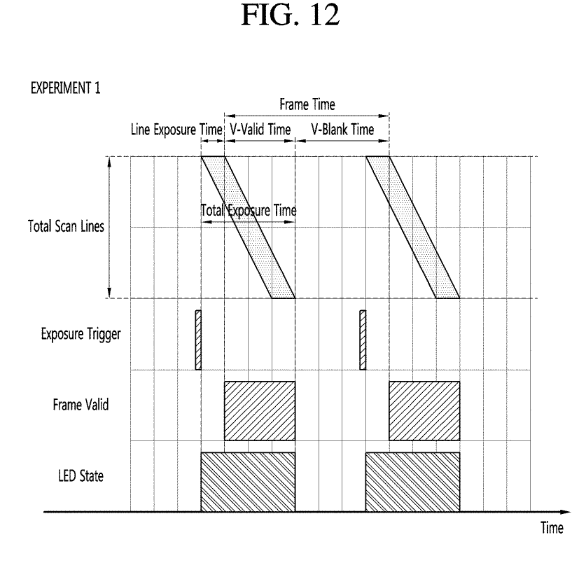

Hereinafter, a signal processing procedure of operating the light module 30 in a procedure of sensing an image at the processor 170 according to Example 1 will be described with reference to FIG. 12.

First, the processor 170 may operate the light module 30 at the line exposure time of the stereo camera 20. That is, in Example 1, the processor 170 may turn both the first and second light emitting elements 31 and 32 on.

Next, the processor 170 may sequentially sense photons incident upon the image sensor at the line exposure time on a per pixel line basis to sense the image. In this process, the light module 30 may continuously radiate light. That is, the processor 170 may turn both the light emitting elements on during a valid time for continuously scanning the pixel lines at a total exposure time.

Next, the processor 170 may turn both the light emitting elements off at a blank time from a time when pixel line scan is completed to an exposure time for capturing a next image.

That is, the processor 170 may turn the light module 30 off at the blank time in the image sensing procedure to operate the light module 30 with low power and low heat.

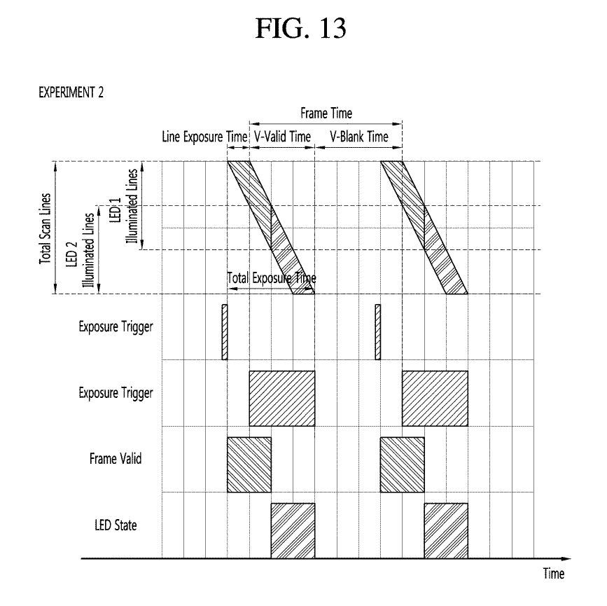

Next, a signal processing procedure of operating the light module 30 in a procedure of sensing an image at the processor 170 according to Example 2 will be described with reference to FIG. 13.

First, the processor 170 may perform control to turn the first light emitting element 31 on and to turn the second light emitting element 32 off at the exposure time of the stereo camera 20 to perform the first control process.

Thereafter, the processor 170 may control the stereo camera 20 to sense the image of the first pixel area W1 matching the first irradiation direction D1 during the first control process.

Next, the processor 170 may control the stereo camera 20 to perform the second control process of turning the first light emitting element 31 off and turning the second light emitting element 32 on when scan of the first pixel area W1 is completed and to sense the image of the second pixel area W2 matching the second irradiation direction D2 during the second control process.

Next, the processor 170 may perform the third control process of turning the first and second light emitting elements 31 and 32 off during the blank time when the captured image is processed after image sensing of the two pixel areas is completed.

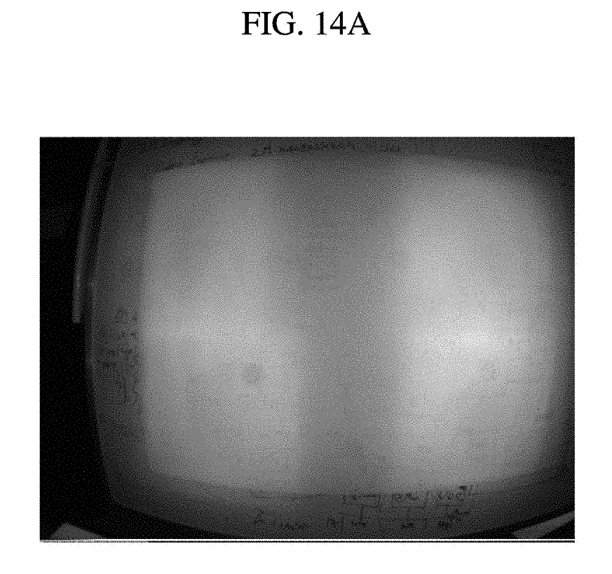

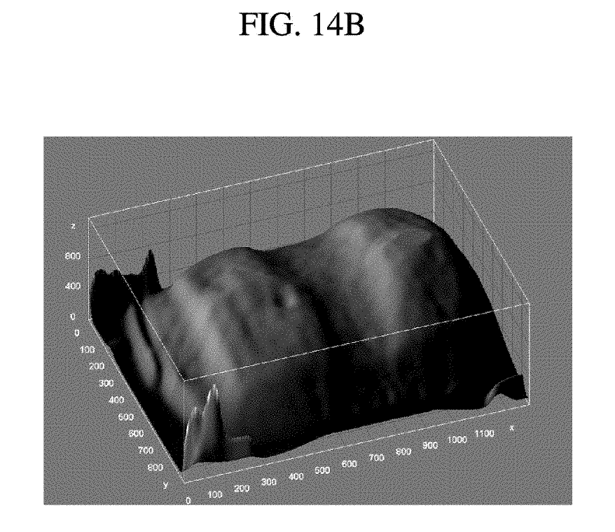

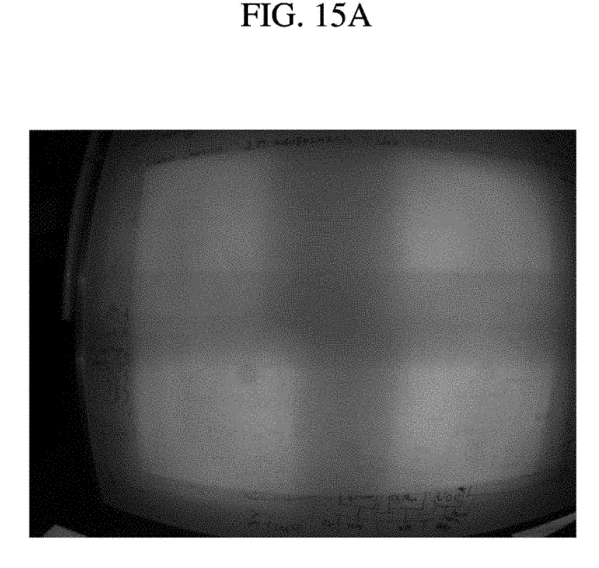

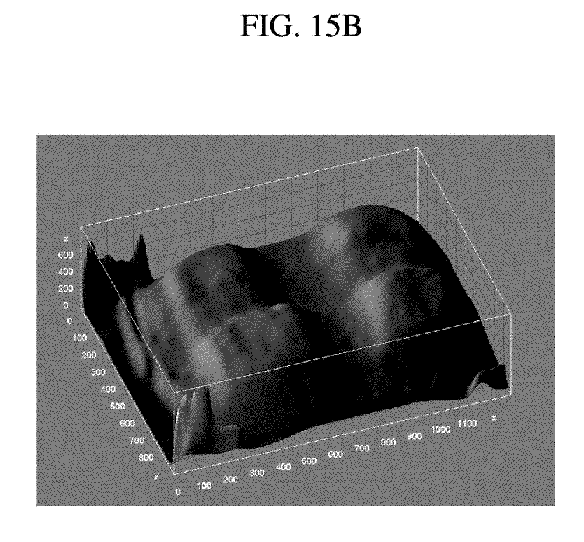

FIGS. 14A and 14B show the amount of light radiated onto the subject W in Example 1 and FIGS. 15A and 15B show the amount of light radiated onto the subject W in Example 2.

Comparison of FIGS. 14A and 14B with FIGS. 15A and 15B shows that the amount of light radiated onto the subject W is not significantly changed according to selective operation of the light emitting elements, such as the selective operations described in Examples 1 and 2.

Table 1 shows a reference example and Examples 1 and 2 according to time of each procedure of sensing the image and operation time of each light emitting element in each procedure.

TABLE 1

| | | | | | Readout | | | |
|---|---|---|---|---|---|---|---|---|
| | H | H-Blank | V | PixelClk | Throughput | Frame rate | Frame Time | V-Valid |
| | (Pixel) | (Pixel) | (Line) | (MHz) | (Pixel/msec) | (FPS) | (ms) | (Pixel) |
| Reference | 1280 | 460 | 960 | 56 | 1.78571E−05 | 30 | 33.33333333 | 1670400 |
| Experiment 1 | 1280 | 460 | 960 | 84 | 1.19048E−05 | 30 | 33.33333333 | 1670400 |
| Experiment 2 | 1280 | 460 | 960 | 96 | 1.04167E−05 | 30 | 33.33333333 | 1670400 |

| | V-Valid Time | V-Blank Time | Line Exposure | Total Exposure | LED TurnOn |
|---|---|---|---|---|---|
| | (ms) | (ms) | Time (ms) | Time (ms) | Ratio (0~1) |
| Reference | 29.82857143 | 3.504761905 | 5 | 34.82857143 | 1 |
| Experiment 1 | 19.88571429 | 13.44761905 | 5 | 24.88571429 | 0.746571429 |
| Experiment 2 | 17.4 | 15.93333333 | 5 | 22.4 | 0.672 |

Referring to Table 1, the light module 30 continuously operates regardless of an image processing procedure in the reference example, the light module 30 is turned off only at the blank time in Example 1, and the light module 30 is turned off at the blank time and the first and second light emitting elements 31 and 32 selectively operate according to image scan area in Example 2.

Table 2 shows power consumption ratios in Examples 1 and 2 as compared to the reference example.

TABLE 2

| | LED duty cycle (%) | Expected Power saving (%) |
|---|---|---|
| Experiment 1 | 67.2% (each LED) | 32.8% |
| Experiment 2 | 67.2% (each LED) | 66.4% |

As compared to the reference example, power consumption is reduced by 32.8% in Example 1 and power consumption is reduced by 66.4% in Example 2.

That is, the processor 170 may not operate the light module 30 even at the blank time when the image is not captured, thereby operating the camera and the light module 30 with low power and low heat.

Further, the processor 170 may enable matching between the image capturing direction and the light irradiation direction to radiate light to a specific area, thereby operating the camera and the light module 30 with low power and low heat.

In the interior camera module 160, since the camera and the light module 30 are provided in the frame body 10 and are sealed, heat generated in the light module 30 may adversely affect image sensing of the stereo camera 20. However, since the light module 30 according to the embodiment may operate with low heat, the stereo camera 20 may acquire a high-quality image.

In addition, the processor 170 may control the irradiation direction of the light module 30 to monitor only a specific area, when only a specific area of the subject W desires to be captured.

Such an interior camera apparatus may efficiently monitor a driver and a passenger when mounted in a vehicle.

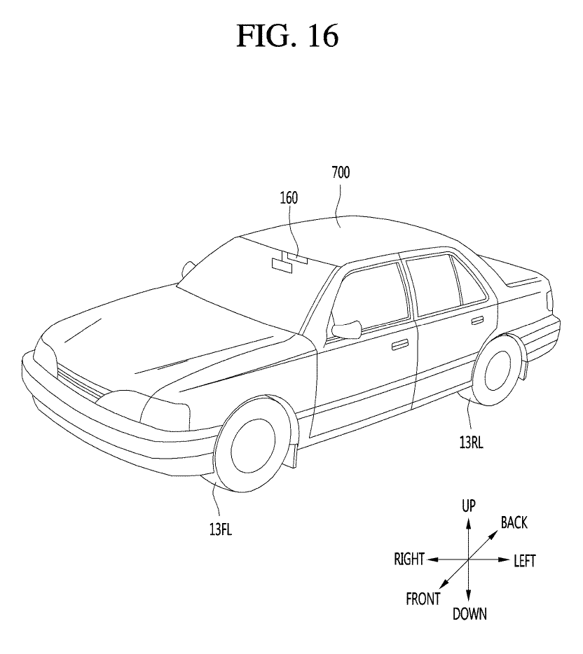

Hereinafter, a method of providing a driver assistance function to a user at a driver assistance apparatus including an interior camera will be described in detail with reference to FIGS. 16 to 28.

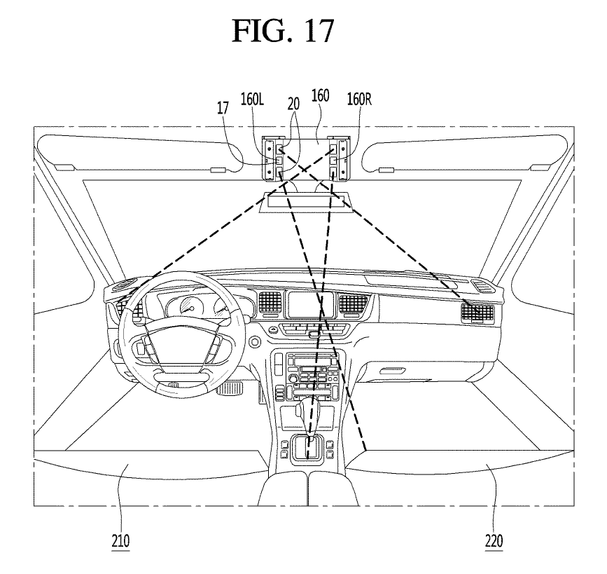

Referring to FIGS. 16 and 17, a vehicle 700 according to an embodiment may include wheels 13FL and 13RL rotating by a power source and a driver assistance apparatus 100 for providing a driver assistance function to a user. The driver assistance apparatus 100 may include an interior camera 160 for capturing the inside of the vehicle.

The driver assistance apparatus 100 may three-dimensionally monitor the inside of the vehicle, provide various user interfaces using the interior camera 160 capable of easily specifying an area to be monitored, and accurately sense a user state.

In addition, the interior camera 160 may be provided on the internal ceiling of the vehicle to monitor a passenger seat area 220 using a first interior camera 160L and to monitor a driver seat area 210 using a second interior camera 160R. In addition, an opened space between the driver seat area 210 and the passenger seat area 220 may be monitored to monitor a portion of back seats.

Referring to FIG. 18, the driver assistance apparatus 100 may include an input unit 110, a communication unit 120, an interface 130, a memory 140, an interior camera 160, a processor 170, a display unit 180, an audio output unit 185 and a power supply 190. The interior camera 160 is provided on the ceiling of the vehicle and may include a stereo camera 20 for capturing the inside of the vehicle and measuring a distance from an object included in the captured image and a light module 30 that is utilized to radiate infrared light in the vehicle in at least two directions.

The driver assistance apparatus 100 is not limited to the specific example shown in FIG. 18, and may have a greater or fewer number of components than the above-described components.

Each component will now be described in detail. The driver assistance apparatus 100 may include the input unit 110 for receiving user input.

For example, a user may input a signal for setting a driver assistance function provided by the driver assistance apparatus 100 or an execution signal for turning the driver assistance apparatus 100 on/off.

The input unit 110 may include at least one of a gesture input unit (e.g., an optical sensor, etc.) for sensing a user gesture, a touch input unit (e.g., a touch sensor, a touch key, a push key (mechanical key), etc.) for sensing touch and a microphone for sensing voice input and receive user input.

In an embodiment, since the interior camera 160 may sense a user state and capture a gesture input by the user and the processor 170 may process an image to recognize the gesture, the interior camera 160 may correspond to a gesture input unit.

The driver assistance apparatus 100 may receive communication information including at least one of navigation information, driving information of another vehicle and traffic information via the communication unit 120. In contrast, the driver assistance apparatus 100 may transmit information on this vehicle via the communication unit 120.

In detail, the communication unit 120 may receive at least one of position information, weather information and road traffic condition information (e.g., transport protocol experts group (TPEG), etc.) from the mobile terminal 600 and/or the server 500.

The communication unit 120 may receive traffic information from the server 500 having an intelligent traffic system (ITS). Here, the traffic information may include traffic signal information, lane information, vehicle surrounding information or position information.

In addition, the communication unit 120 may receive navigation information from the server 500 and/or the mobile terminal 600. Here, the navigation information may include at least one of map information related to vehicle driving, lane information, vehicle position information, set destination information and route information according to the destination.

For example, the communication unit 120 may receive the real-time position of the vehicle as the navigation information. In detail, the communication unit 120 may include a global positioning system (GPS) module and/or a Wi-Fi (Wireless Fidelity) module and acquire the position of the vehicle.

In addition, the communication unit 120 may receive driving information of the other vehicle 510 from the other vehicle 510 and transmit information on this vehicle, thereby sharing driving information between vehicles. Here, the shared driving information may include vehicle traveling direction information, position information, vehicle speed information, acceleration information, moving route information, forward/reverse information, adjacent vehicle information and turn signal information.

In addition, when a user rides in the vehicle, the mobile terminal 600 of the user and the driver assistance apparatus 100 may pair with each other automatically or by executing a user application.

The communication unit 120 may exchange data with the other vehicle 510, the mobile terminal 600 or the server 500 in a wireless manner.

In detail, the communication module 120 can perform wireless communication using a wireless data communication method. As the wireless data communication method, technical standards or communication methods for mobile communications (for example, Global System for Mobile Communication (GSM), Code Division Multiple Access (CDMA), CDMA2000 (Code Division Multiple Access 2000), EV-DO (Evolution-Data Optimized), Wideband CDMA (WCDMA), High Speed Downlink Packet Access (HSDPA), HSUPA (High Speed Uplink Packet Access), Long Term Evolution (LTE), LTE-A (Long Term Evolution-Advanced), and the like) may be used.

The communication unit module 120 is configured to facilitate wireless Internet technology. Examples of such wireless Internet technology include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like.

In addition, the communication unit 120 is configured to facilitate short-range communication. For example, short-range communication may be supported using at least one of Bluetooth™, Radio Frequency IDentification (RFID), Infrared Data Association (IrDA), Ultra-Wideband (UWB), ZigBee, Near Field Communication (NFC), Wireless-Fidelity (Wi-Fi), Wi-Fi Direct, Wireless USB (Wireless Universal Serial Bus), and the like.

In addition, the driver assistance apparatus 100 may pair with the mobile terminal located inside the vehicle using a short-range communication method and wirelessly exchange data with the other vehicle 510 or the server 500 using a long-distance wireless communication module of the mobile terminal.

Next, the driver assistance apparatus 100 may include the interface 130 for receiving data of the vehicle and transmitting a signal processed or generated by the processor 170.

In detail, the driver assistance apparatus 100 may receive at least one of driving information of another vehicle, navigation information and sensor information via the interface 130.

In addition, the driver assistance apparatus 100 may transmit a control signal for executing a driver assistance function or information generated by the driver assistance apparatus 100 to the controller 770 of the vehicle via the interface 130.

In an embodiment, the driver assistance apparatus 100 may sense a user gesture captured through the interior camera 160 and transmit a driver assistance function control signal according to the user gesture to the vehicle controller 770 through the interface 130, thereby performing control to execute various functions of the vehicle.

To this end, the interface 130 may perform data communication with at least one of the controller 770 of the vehicle, an audio-video-navigation (AVN) apparatus 400 and the sensing unit 760 using a wired or wireless communication method.

In detail, the interface 130 may receive navigation information by data communication with the controller 770, the AVN apparatus 400 and/or a separate navigation apparatus.

In addition, the interface 130 may receive sensor information from the controller 770 or the sensing unit 760.

Here, the sensor information may include at least one of vehicle traveling direction information, vehicle position information, vehicle speed information, acceleration information, vehicle tilt information, forward/reverse information, fuel information, information on a distance from a preceding/rear vehicle, information on a distance between a vehicle and a lane and turn signal information, etc.

The sensor information may be acquired from a heading sensor, a yaw sensor, a gyro sensor, a position module, a vehicle forward/reverse sensor, a wheel sensor, a vehicle speed sensor, a vehicle tilt sensor, a battery sensor, a fuel sensor, a tire sensor, a steering sensor based on rotation of the steering wheel, a vehicle interior temperature sensor, a vehicle interior humidity sensor, a door sensor, etc. The position module may include a GPS module for receiving GPS information.

The interface 130 may receive user input via the user input unit 110 of the vehicle. The interface 130 may receive user input from the input unit of the vehicle or via the controller 770. That is, when the input unit is provided in the vehicle, user input may be received via the interface 130.

In addition, the interface 130 may receive traffic information acquired from the server. The server 500 may be located at a traffic control surveillance center for controlling traffic. For example, when traffic information is received from the server 500 via the communication unit 120 of the vehicle, the interface 130 may receive traffic information from the controller 770.

Next, the memory 140 may store a variety of data for overall operation of the driver assistance apparatus 100, such as a program for processing or control of the controller 170.

In addition, the memory 140 may store data and commands for operation of the driver assistance apparatus 100 and a plurality of application programs or applications executed in the driver assistance apparatus 100. At least some of such application programs may be downloaded from an external server through wireless communication. At least one of such application programs may be installed in the driver assistance apparatus 100 upon release, in order to provide the basic function (e.g., the driver assistance information guide function) of the driver assistance apparatus 100.

Such application programs may be stored in the memory 140 and may be executed to perform operation (or function) of the driver assistance apparatus 100 by the processor 170.

The memory 140 may store data for checking an object included in an image. For example, the memory 140 may store data for checking a predetermined object using a predetermined algorithm when the predetermined object is detected from an image of the vicinity of the vehicle acquired through the camera 160.

For example, the memory 140 may store data for checking the object using the predetermined algorithm when the predetermined algorithm such as a lane, a traffic sign, a two-wheeled vehicle and a pedestrian is included in an image acquired through the camera 160.

The memory 140 may be implemented in a hardware manner using at least one selected from among a flash memory, a hard disk, a solid state drive (SSD), a silicon disk drive (SDD), a micro multimedia card, a card type memory (e.g., an SD or XD memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk and an optical disc.

In addition, the driver assistance apparatus 100 may operate in association with a network storage for performing a storage function of the memory 140 over the Internet.

Next, the interior camera 160 may capture the inside of the vehicle and acquire an internal state of the vehicle as monitoring information.

The monitoring information sensed by the interior camera 160 may include at least one of face-scan information, iris-scan information, retina-scan information and hand geometry information.

For example, the interior camera 160 may monitor the inside of the vehicle to acquire driver state information and include at least two camera modules to recognize a gesture input by a driver or passenger. Since the interior camera is a stereo camera, it is possible to accurately recognize the position of the gesture.

In addition, the interior camera 160 may radiate infrared light to only an area to be monitored through the light module 30 to control the monitoring area.

In detail, the interior camera 160 may capture a user inside the vehicle and the processor 170 may analyze the image to acquire the monitoring information.

In greater detail, the driver assistance apparatus 100 may capture the inside of the vehicle using the interior camera 160, and the processor 170 may analyze the acquired image of the inside of the vehicle to detect the object inside the vehicle, determine the attributes of the object and generate the monitoring information.

In detail, the processor 170 may perform object analysis such as detection of the object from the captured image through image processing, tracking of the object, measurement of a distance from the object and checking of the object, thereby generating image information.

In order to enable the processor 170 to more easily analyze the object, in the embodiment, the interior camera 160 may be a stereo camera 20 for capturing the image and measuring the distance from the object.

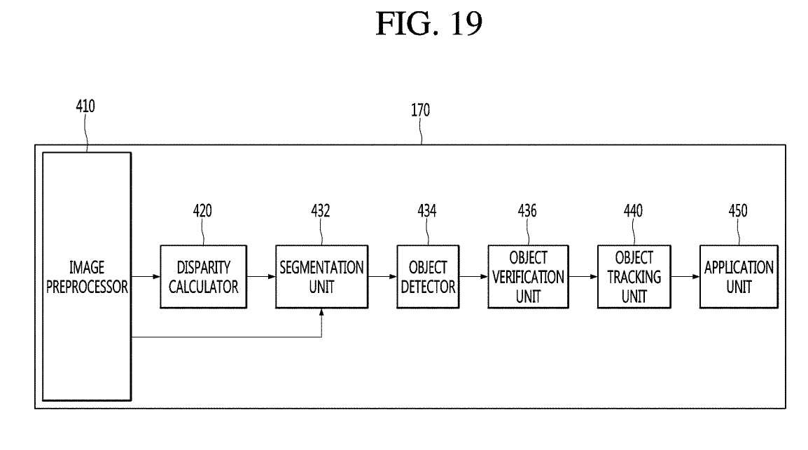

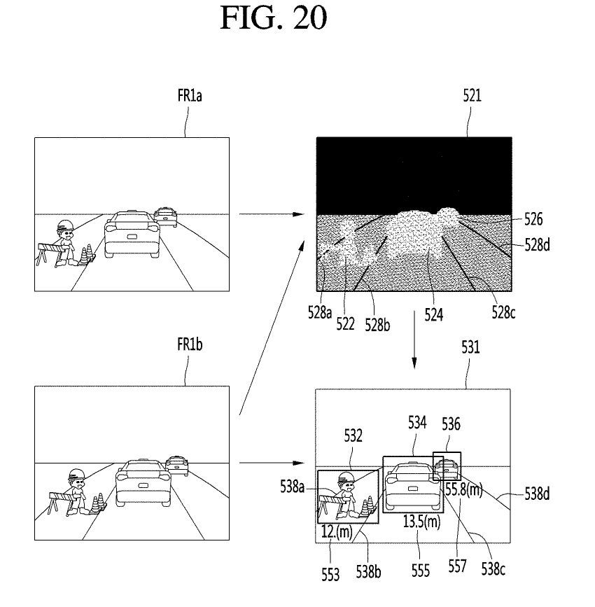

Hereinafter, referring to FIGS. 19 to 20, the stereo camera 20 and a method of detecting monitoring information by the processor 170 using the stereo camera will be described in greater detail.

Referring to FIG. 19, as one example of the block diagram of the internal configuration of the processor 170, the processor 170 of the driver assistance apparatus 100 may include an image preprocessor 410, a disparity calculator 420, an object detector 434, an object tracking unit 440 and an application unit 450. Although an image is processed in order of the image preprocessor 410, the disparity calculator 420, the object detector 434, the object tracking unit 440 and the application unit 450 in FIG. 19 and the following description, the present invention is not limited thereto.

The image preprocessor 410 may receive an image from the stereo camera 20 and perform preprocessing.

In detail, the image preprocessor 410 may perform noise reduction, rectification, calibration, color enhancement, color space conversion (CSC), interpolation, camera gain control, etc. of the image. An image having definition higher than that of the stereo image captured by the stereo camera 20 may be acquired.

The disparity calculator 420 may receive the images processed by the image preprocessor 410, perform stereo matching of the received images, and acquire a disparity map according to stereo matching. That is, disparity information of the stereo image of the front side of the vehicle may be acquired.

In some implementations, stereo matching may be performed in units of pixels of the stereo images or predetermined block units. The disparity map may refer to a map indicating the numerical value of binocular parallax information of the stereo images, that is, the left and right images.

The segmentation unit 432 may perform segmentation and clustering with respect to at least one image based on the disparity information from the disparity calculator 420.

In detail, the segmentation unit 432 may segment at least one stereo image into a background and a foreground based on the disparity information.

For example, an area in which the disparity information is less than or equal to a predetermined value within the disparity map may be calculated as the background and excluded. Therefore, the foreground may be segmented. As another example, an area in which the disparity information is greater than or equal to a predetermined value within the disparity map may be calculated as the foreground and extracted. Therefore, the foreground may be segmented.

The background and the foreground may be segmented based on the disparity information extracted based on the stereo images to reduce signal processing speed, the amount of processed signals, etc. upon object detection.

Next, the object detector 434 may detect the object based on the image segment from the segmentation unit 432.

That is, the object detector 434 may detect the object from at least one image based on the disparity information.

In detail, the object detector 434 may detect the object from at least one image. For example, the object may be detected from the foreground segmented by image segmentation.

Next, the object verification unit 436 may classify and verify the segmented object.

To this end, the object verification unit 436 may use an identification method using a neural network, a support vector machine (SVM) method, an identification method by AdaBoost using Haar-like features or a histograms of oriented gradients (HOG) method.

The object verification unit 436 may compare the objects stored in the memory 140 and the detected object and verify the object.

For example, the object verification unit 436 may verify a peripheral vehicle, a lane, a road surface, a traffic sign, a danger zone, a tunnel, etc. located in the vicinity of the vehicle.

The object tracking unit 440 may track the verified object. For example, the objects in the sequentially acquired stereo images may be verified, motion or motion vectors of the verified objects may be calculated and motion of the objects may be tracked based on the calculated motion or motion vectors. A peripheral vehicle, a lane, a road surface, a traffic sign, a danger zone, a tunnel, etc. located in the vicinity of the vehicle may be tracked.

Next, the application unit 450 may calculate a degree of risk, etc. based on various objects located in the vicinity of the vehicle, for example, another vehicle, a lane, a road surface, a traffic sign, etc. In addition, possibility of collision with a preceding vehicle, whether a vehicle slips, etc. may be calculated.

The application unit 450 may output a message indicating such information to the user as driver assistance information based on the calculated degree of risk, possibility of collision or slip. Alternatively, a control signal for vehicle attitude control or driving control may be generated as vehicle control information.

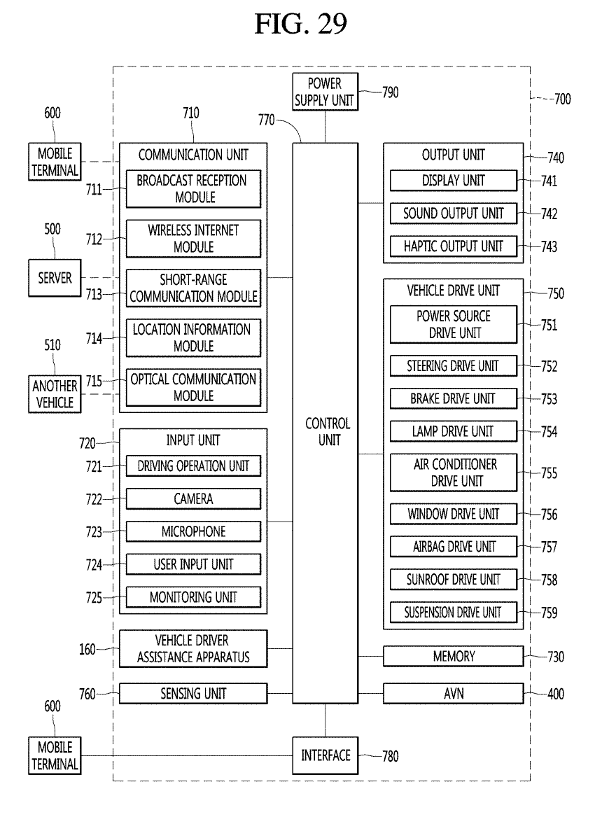

The image preprocessor 410, the disparity calculator 420, the segmentation unit 432, the object detector 434, the object verification unit 436, the object tracking unit 440 and the application unit 450 may be included in the image processor (see FIG. 29) of the processor 170.

In some embodiments, the processor 170 may include only some of the image preprocessor 410, the disparity calculator 420, the segmentation unit 432, the object detector 434, the object verification unit 436, the object tracking unit 440 and the application unit 450. If the stereo camera 20 includes a mono stereo camera 20 or an around view stereo camera 20, the disparity calculator 420 may be excluded. In some embodiments, the segmentation unit 432 may be excluded.

Referring to FIG. 20, during a first frame period, the stereo camera 20 may acquire stereo images.

The disparity calculator 420 of the processor 160 receives stereo images FR1a and FR1b processed by the image preprocessor 410, performs stereo matching with respect to the stereo images FR1a and FR1b and acquires a disparity map 520.

The disparity map 520 indicates the levels of binocular parallax between the stereo images FR1a and FR1b. As a disparity level increases, a distance from a vehicle may decrease and, as the disparity level decreases, the distance from the vehicle may increase.

When such a disparity map is displayed, luminance may increase as the disparity level increases and decrease as the disparity level decreases.

In the figure, disparity levels respectively corresponding to first to fourth lanes 528a, 528b, 528c and 528d and disparity levels respectively corresponding to a construction area 522, a first preceding vehicle 524 and a second preceding vehicle 526 are included in the disparity map 520.

The segmentation unit 432, the object detector 434 and the object verification unit 436 may perform segmentation, object detection and object verification with respect to at least one of the stereo images FR1a and FR1b based on the disparity map 520.

In the figure, object detection and verification are performed with respect to the second stereo image FR1b using the disparity map 520.

That is, object detection and verification are performed with respect to the first to fourth lanes 538a, 538b, 538c and 538d, the construction area 532, the first preceding vehicle 534 and the second preceding vehicle 536 of the image 530.

Through such image processing, the driver assistance apparatus 100 may acquire the state of the user inside of the vehicle, the gesture of the user, the position of the gesture, etc. as the monitoring information.

Next, the driver assistance apparatus 100 may further include a display unit for displaying a graphic image of the driver assistance function.

The processor 170 may receive the user's gesture for controlling the driver assistance function using the interior camera 160 and provide a graphical image related to the driver assistance function through the display unit, thereby providing the graphical user interface to the user.

The display unit 180 may include a plurality of displays.

In detail, the display unit 180 may include a first display 180a for projecting and displaying a graphic image onto and on a vehicle windshield W. That is, the first display 180a is a head up display (HUD) and may include a projection module for projecting the graphic image onto the windshield W. The graphic image projected by the projection module may have predetermined transparency. Accordingly, a user may simultaneously view the front and rear sides of the graphic image.

The graphic image may overlap the image projected onto the windshield W to achieve augmented reality (AR).

The display unit may include a second display 180b separately provided inside the vehicle to display an image of the driver assistance function.

In detail, the second display 180b may be a display of a vehicle navigation apparatus or a cluster located at an internal front side of the vehicle.

The second display 180b may include at least one selected from among a Liquid Crystal Display (LCD), a Thin Film Transistor LCD (TFT LCD), an Organic Light Emitting Diode (OLED), a flexible display, a 3D display, and an e-ink display.

The second display 180b may be combined with a touch input unit to achieve a touchscreen.

Next, the audio output unit 185 may audibly output a message for explaining the function of the driver assistance apparatus 100 and checking whether the driver assistance function is performed. That is, the driver assistance apparatus 100 may provide explanation of the function of the driver assistance apparatus 100 via visual display of the display unit 180 and audio output of the audio output unit 185.

Next, the haptic output unit may output an alarm for the driver assistance function in a haptic manner. For example, the driver assistance apparatus 100 may output vibration to the user when a warning is included in at least one of navigation information, traffic information, communication information, vehicle state information, advanced driver assistance system (ADAS) function and other driver convenience information.

The haptic output unit may provide directional vibration. For example, the haptic output unit may be provided in a steering apparatus for controlling steering to output vibration. Left or right vibration may be output according to the left and right sides of the steering apparatus to enable directional haptic output.

In addition, the power supply 190 may receive power and supply power to be utilized for operation of the components under control of the processor 170.

Lastly, the driver assistance apparatus 100 may include the processor 170 for controlling overall operation of the units of the driver assistance apparatus 100.

In addition, the processor 170 may control at least some of the components described with reference to FIG. 18 in order to execute the application program. Further, the processor 170 may operate by combining at least two of the components included in the driver assistance apparatus 100es, in order to execute the application program.

The processor 170 may be implemented in a hardware manner using at least one selected from among Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors 170, and electric units for the implementation of other functions.

The processor 170 may be controlled by the controller or may control various functions of the vehicle through the controller.

The processor 170 may control overall operation of the driver assistance apparatus 100 in addition to operation related to the application programs stored in the memory 140. The processor 170 may process signals, data, information, etc. via the above-described components or execute the application programs stored in the memory 140 to provide appropriate information or functions to the user.

Hereinafter, examples of a user interface for enabling the processor 170 to receive user gesture input through the interior camera 160 and to control the driver assistance function will be described.

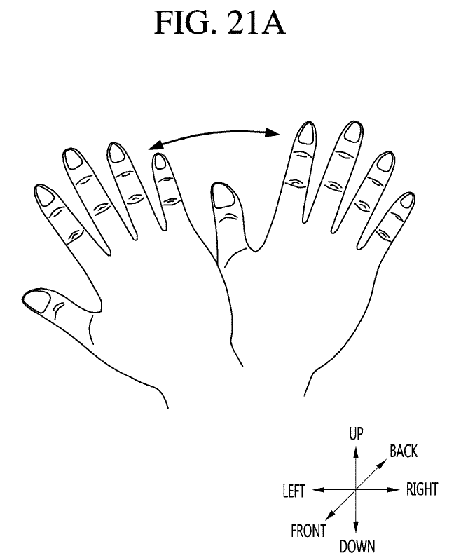

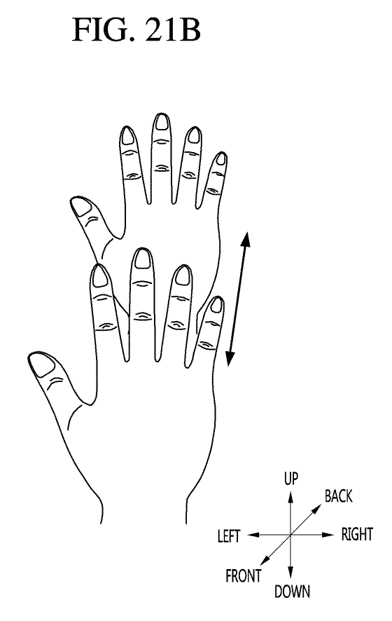

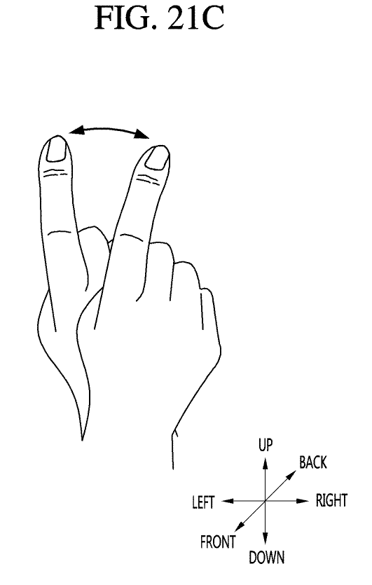

Referring to FIGS. 21A to 21C, since the interior camera 160 captures an object inside the vehicle and measures a distance from the object, it is possible to three-dimensionally scan the inside of the vehicle.

Accordingly, the processor 170 may recognize a 3D gesture of a user obtained through the stereo camera 20.

In detail, referring to FIG. 21A, the processor 170 may capture a horizontal gesture of waving a user's hand in a horizontal direction (in up, down, left and right directions) using the interior camera 160, process the captured image and recognize horizontal gesture (2D gesture) input.

In addition, referring to FIG. 21B, the processor 170 may capture a 3D gesture of moving a user's hand in a vertical direction (front-and-rear direction) using the interior camera 160, process the captured image and recognize horizontal gesture (3D gesture) input.

In addition, referring to FIG. 21C, the processor 170 may focus on a user's finger in a monitoring area and recognize a click gesture of moving the user's finger in a vertical and/or horizontal direction.

The processor 170 may focus on a user's hand in a monitoring area through the stereo camera 20, recognize a 2D or 3D gesture of moving the user's hand and receive a variety of gesture input of the user.

The interior camera 160 is the stereo camera 20 and thus may accurately detect the input position of the gesture. The processor 170 may perform control to perform the driver assistance function changed according to the input position of the gesture of the user in the vehicle.

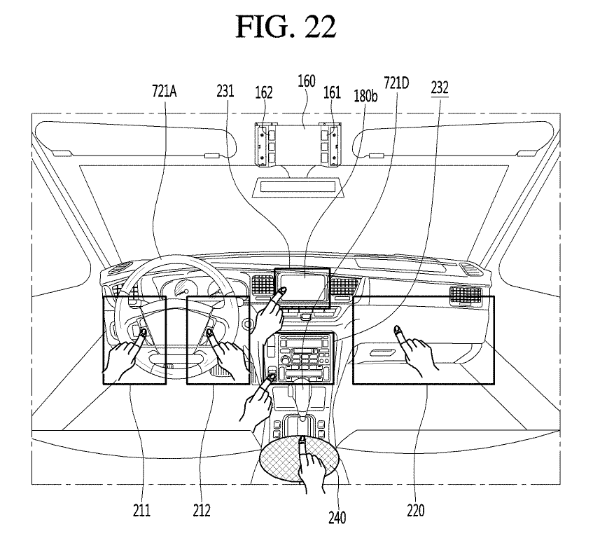

Referring to FIG. 22, given the same gesture, the position of the gesture may vary. The processor 170 may generate a control signal to control the driver assistance function changed according to the input position of the gesture.

In detail, when a gesture is input in an area 211 located at the left side of a steering wheel, the processor 170 may regard the user gesture as vehicle lamp control input and generate a lamp control signal according to the user gesture. For example, when the user raises a user's hand at the left side of the steering wheel, a high beam lamp may be turned on.

In addition, when a gesture is input in an area 121 located at the right side of the steering wheel, the processor 170 may regard the user gesture as vehicle turn signal lamp control input and generate a turn signal lamp control signal according to the user gesture. For example, when the user raises a user's hand at the right side of the steering wheel, a right turn signal lamp may be turned on.

When a gesture is input in an area 231 located in front of the second display 180b, the processor 170 may provide a graphical user interface in association with a graphical image displayed on the second display 18b. For example, the graphical image for navigation may be displayed on the second display 180b and the user may control a navigation function through gesture input such as clicking of the graphical image.

When a gesture is input in a vehicular air-conditioner control panel area 232, the processor 170 may generate an air-conditioner control signal according to the user gesture. For example, when the user makes a gesture of raising a user's hand in front of the air conditioner, the wind strength of the air conditioner may increase.

When a gesture is input in a passenger seat area 220, the processor 170 may generate a control signal for controlling various driver assistance functions related to the passenger seat. For example, the user may make a gesture in the passenger seat area to control the position of the passenger seat or the air conditioner of the passenger seat.

Further, the processor 170 may perform control to specify a main monitoring area 240 and to perform the driver assistance function according to input of a pointing gesture and control gesture of the user in the main monitoring area 240.

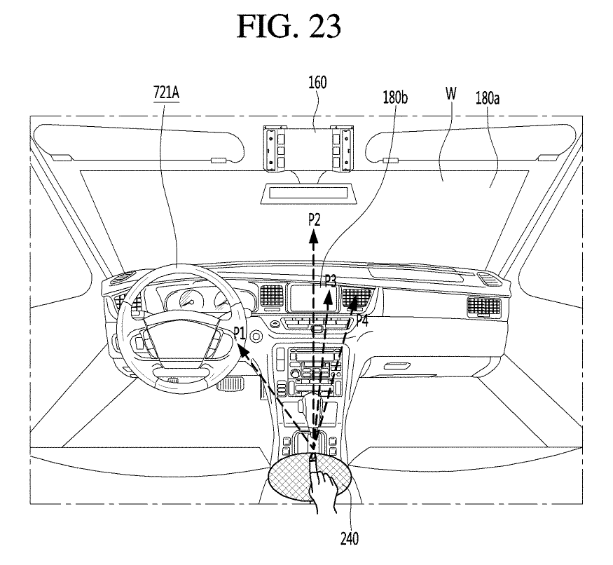

In detail, referring to FIG. 23, an area where the driver's hand is easily located between the driver seat and the passenger seat in the vehicle may be specified as the main monitoring area 240. The user may make a pointing gesture pointing to an object to be controlled in the main monitoring area 240 and input the control gesture for the object to be controlled after the pointing gesture. The processor 170 may recognize the gestures, generate control signals for the pointing gesture and the control gesture and control the driver assistance function.

For example, the processor 170 may provide a graphical user interface for controlling the driver assistance function, upon recognizing that the driver points to the first display 180a (P2) and makes the control gesture of controlling the graphical image displayed on the first display 180a.

The processor 170 may control the light module 30 of the interior camera 160 to radiate infrared light in one area of the vehicle to be monitored, thereby controlling the monitoring area of the vehicle. That is, the processor 170 may selectively operate at least two light emitting elements of the light module 30 that are utilized to radiate infrared light in different directions to radiate infrared light to the area to be monitored and monitor only the radiated area.

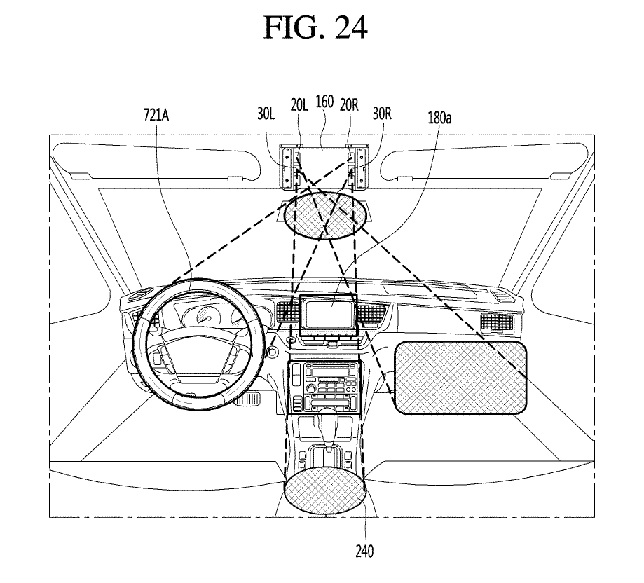

Referring to FIG. 24, the processor 170 may perform control such that the light module 30 radiates light onto the steering input unit 721A (e.g., a steering wheel), thereby setting a steering wheel area as the monitoring area.

The processor 170 may perform control such that the light module 30 radiates light to the main monitoring area 240, thereby setting the main monitoring area 240 as the monitoring area.

The processor 170 may perform control such that the light module 30 radiates light onto the passenger seat, thereby setting the passenger area as the monitoring area.

That is, the processor 170 may control the interior camera 160 to set a specific internal area of the vehicle as the monitoring area.

Such a monitoring area may be changed according to vehicle traveling state.

That is, the processor may control the size of the monitoring area according to vehicle traveling state.

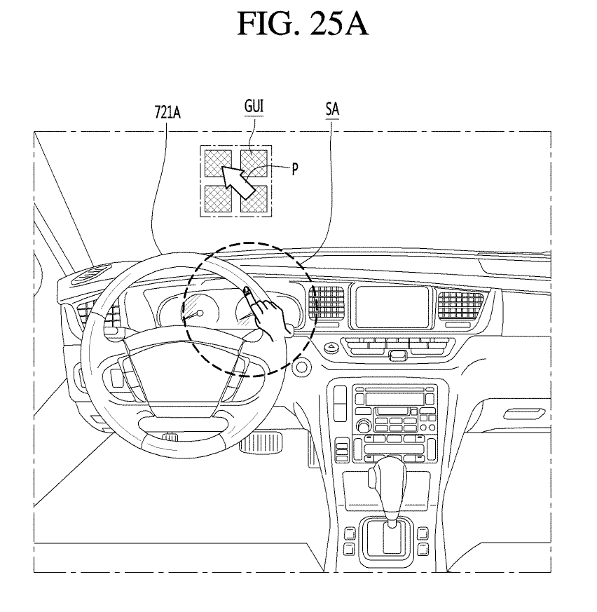

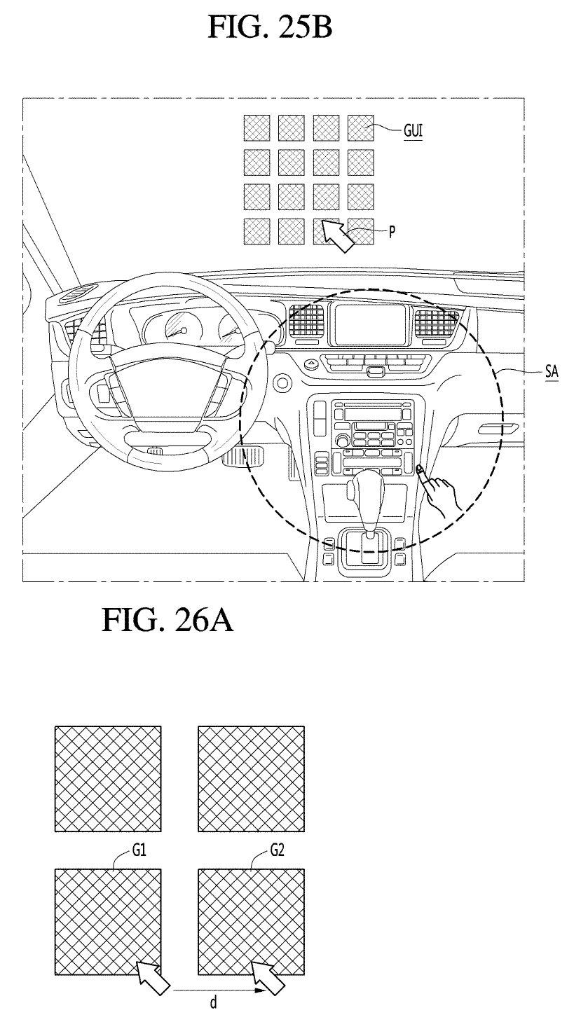

In detail, referring to FIG. 25A, the processor 170 may decrease the size of the monitoring area and restrict the position of the monitoring area (SA) to the vicinity of the steering wheel, if the speed of the vehicle is equal to or greater than a predetermined speed. In addition, the processor 170 may decrease the number of types of the driver assistance function to be controlled. That is, the processor 170 may provide a low-resolution graphical user interface (GUI) when the speed of the vehicle is high.

The driver may be enabled to input a gesture only in the vicinity of the steering wheel to focus on driving, thereby leading to safe driving.

In contrast, referring to FIG. 25B, the processor 170 may increase the size of the monitoring area SA and release restriction of the position of the monitoring area, if the speed of the vehicle is less than the predetermined speed. In addition, the processor 170 may increase the number of types of the driver assistance function to be controlled. That is, the processor 170 may provide a high-resolution graphical user interface when the speed of the vehicle is low.

Hereinafter, the high-resolution graphical user interface and the low-resolution graphical user interface will be described.

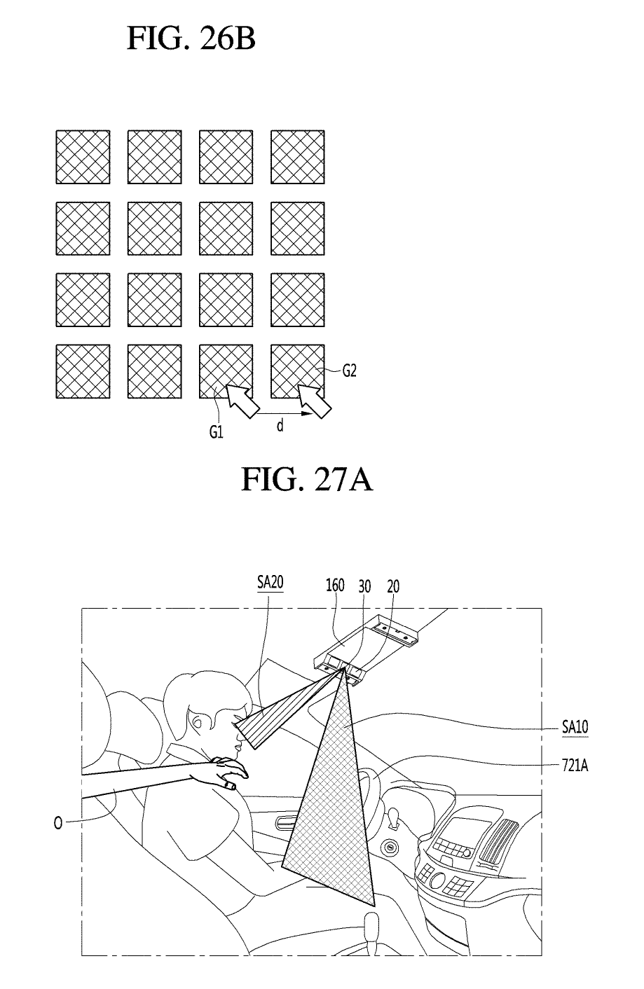

FIG. 26A shows the low-resolution graphical user interface and a predetermined number or less of graphical images may be displayed on the display unit. That is, the number of graphical images is small and the graphical images G1 and G2 having large sizes may be displayed.

A cursor P may move according to movement of a user gesture. It is possible to perform the driver assistance function by taking a gesture of moving the cursor P to the graphical images G1 and G2 and then clicking.

FIG. 26B shows the high-resolution graphical user interface and greater than the predetermined number of graphical images G1 and G2 may be displayed on the display unit. The sizes of the graphical images G1 and G2 may decrease in order to display more graphical images G1 and G2.

The cursor P may move according to movement of a user gesture. It is possible to perform the driver assistance function, by making a gesture of moving the cursor P to the graphical images G1 and G2 and then clicking.

At this time, the processor 170 may differently control movement of the cursor P according to movement of the user gesture in the low-resolution graphical user interface and movement of the cursor P according to movement of the user gesture in the high-resolution graphical user interface. That is, the processor 170 may differently control sensitivity in movement of the cursor P according to gesture input based on resolution.

For example, the processor 170 may increase sensitivity to increase the movement distance of the cursor P according to movement of the gesture with low resolution and decrease the movement distance of the cursor P according to movement of the gesture with high resolution.

The processor 170 may control the display unit 180 to provide a low-resolution graphical user interface when the number of elements to be controlled in the driver assistance function to be controlled by the user is equal to or less than a predetermined value and control the display unit 180 to provide a high-resolution graphical user interface when the number of elements to be controlled in the driver assistance function to be controlled by the user is greater than the predetermined value.

The processor 170 may restrict the monitoring position to a specific position in association with a vehicle traveling state.

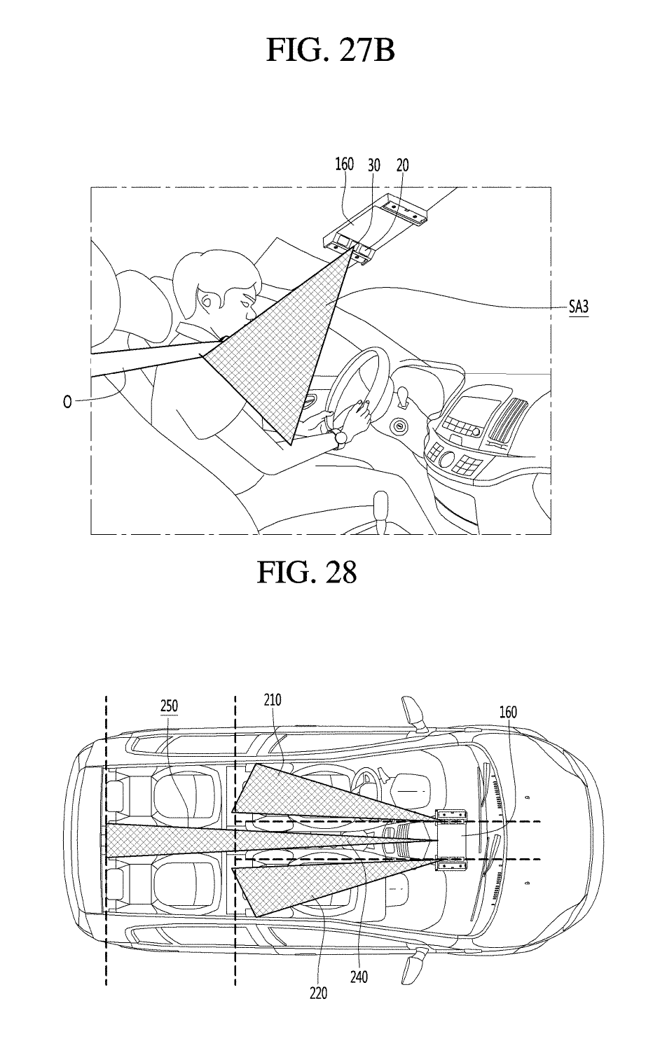

In detail, referring to FIG. 27A, the processor 170 may restrict the monitoring position to a driver's eye area SA20 and a steering wheel vicinity area SA10, if the speed of the vehicle is equal to or greater than a predetermined value. Therefore, a gesture made by a person sitting in a back seat can be prevented from being mistakenly recognized as a gesture O made by a person sitting in a driver seat.

In contrast, referring to FIG. 27B, the processor 170 may restrict the monitoring position to the entire driver seat SA3 if the speed of the vehicle is less than the predetermined value.

The complex interior camera 160 may capture all of a driver seat area 210, a passenger seat area 220, a main monitoring area 240 and a back seat area 250. That is, the complex interior camera 160 may include a first interior camera 160L and a second interior camera 160R to distinguish between right and left areas, specify and monitor the driver seat, the passenger seat and the front center area by controlling on/off of the light module and sense a back seat area 250.

The processor 170 may differently set rights on the driver assistance functions controlled in the driver seat area 210, the passenger seat area 220 and the back seat area 250.

In detail, the processor 170 may monitor the driver seat area 210 to perform various driver assistance functions according to the state of the driver and give rights for controlling the driver assistance function of the driver seat to a gesture input in the driver seat area. For example, it is possible to perform the driver assistance functions such as control of the air conditioner of the driver seat, control of the position of the driver seat, control of the turn sign lamp of the vehicle, etc., using the gesture input in the driver seat area.

The processor 170 may monitor the passenger seat area 220 to perform various driver assistance functions according to the state of the passenger sitting in the passenger seat and give rights for controlling the driver assistance function of the driver seat to a gesture input in the passenger seat area. For example, it is possible to perform the driver assistance functions such as control of the air conditioner of the passenger seat, control of the position of the passenger seat, etc., using the gesture input in the passenger seat area.

The processor 170 may monitor the back seat area 250 to perform various driver assistance functions according to the state of the passenger sitting in the back seat and give rights for controlling the driver assistance function of the driver seat to a gesture input in the back seat area.

For example, it is possible to perform the driver assistance functions such as control of the air conditioner of the back seat, control of the position of the back seat, etc., using the gesture input in the back seat area.

In summary, the driver assistance apparatus 100 may three-dimensionally scan the inside of the vehicle, monitor the driver seat, the passenger seat and the back seat area 250, and provide various user interfaces through the interior camera 160 capable of specifying the monitoring area.

The interior camera 160 may be provided on the ceiling of the vehicle or may be included in the vehicle.

Referring to FIG. 29, the interior camera 160 may be included in the vehicle 700. For example, the interior camera 160 may be provided on the ceiling of the vehicle such that the first interior camera module captures the driver seat and the second interior camera module captures the passenger seat.

The vehicle 700 may include a communication unit 710, an input unit 720, a sensing unit 760, an output unit 740, a vehicle drive unit 750, a memory 730, an interface 780, a controller 770, a power supply unit 790, an interior camera 160 and AVN apparatus 400. Here, among the units included in the driver assistance apparatus 100 and the units of the vehicle 700, the units having the same names are described as being included in the vehicle 700.

The communication unit 710 may include one or more modules which permit communication such as wireless communication between the vehicle and the mobile terminal 600, between the vehicle and the external server 500 or between the vehicle and the other vehicle 510. Further, the communication unit 710 may include one or more modules which connect the vehicle to one or more networks.

The communication unit 710 includes a broadcast receiving module 711, a wireless Internet module 712, a short-range communication module 713, and an optical communication module 715.

The broadcast reception module 711 receives a broadcast signal or broadcast related information from an external broadcast management server through a broadcast channel. Here, the broadcast includes a radio broadcast or a TV broadcast.

The wireless Internet module 712 refers to a wireless Internet access module and may be provided inside or outside the vehicle. The wireless Internet module 712 transmits and receives a wireless signal through a communication network according to wireless Internet access technologies.

Examples of such wireless Internet access technologies include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 712 may transmit/receive data according to one or more of such wireless Internet technologies, and other Internet technologies as well. For example, the wireless Internet module 712 may wirelessly exchange data with the external server 500. The wireless Internet module 712 may receive weather information and road traffic state information (e.g., transport protocol experts group (TPEG) information) from the external server 500.

The short-range communication module 713 is configured to facilitate short-range communication. Such short-range communication may be supported using at least one of Bluetooth™, Radio Frequency Identification (RFID), Infrared Data Association (IrDA), Ultra-Wideband (UWB), ZigBee, Near Field Communication (NFC), Wireless-Fidelity (Wi-Fi), Wi-Fi Direct, Wireless USB (Wireless Universal Serial Bus), and the like.

The short-range communication module 713 may form a wireless local area network to perform short-range communication between the vehicle and at least one external device. For example, the short-range communication module 713 may wirelessly exchange data with the mobile terminal 600. The short-range communication module 713 may receive weather information and road traffic state information (e.g., transport protocol experts group (TPEG) information) from the mobile terminal 600. When a user rides in the vehicle, the mobile terminal 600 of the user and the vehicle may pair with each other automatically or by executing the application of the user.

A location information module 714 acquires the location of the vehicle and a representative example thereof includes a global positioning system (GPS) module. For example, the vehicle may acquire the location of the vehicle using a signal received from a GPS satellite upon utilizing the GPS module.

The optical communication module 715 may include a light emitting unit and a light reception unit.

The light reception unit may convert a light signal into an electric signal and receive information. The light reception unit may include a photodiode (PD) for receiving light. The photodiode may covert light into an electric signal. For example, the light reception unit may receive information on a preceding vehicle through light emitted from a light source included in the preceding vehicle.

The light emitting unit may include at least one light emitting element for converting electrical signals into a light signal. Here, the light emitting element may be a Light Emitting Diode (LED). The light emitting unit converts electrical signals into light signals to emit the light. For example, the light emitting unit may externally emit light via flickering of the light emitting element corresponding to a prescribed frequency. In some embodiments, the light emitting unit may include an array of a plurality of light emitting elements. In some embodiments, the light emitting unit may be integrated with a lamp provided in the vehicle. For example, the light emitting unit may be at least one selected from among a headlight, a taillight, a brake light, a turn signal, and a sidelight. For example, the optical communication module 715 may exchange data with the other vehicle 510 via optical communication.

The input unit 720 may include a driving operation unit 721, a camera 195, a microphone 723 and a user input unit 724.

The driving operation unit 721 receives user input for driving of the vehicle (see FIG. 7). The driving operation unit 721 may include a steering input unit 721A, a shift input unit 721D, an acceleration input unit 721C and a brake input unit 721B.

The steering input unit 721A is configured to receive user input with regard to the direction of travel of the vehicle. The steering input unit 721A may include a steering wheel using rotation. In some embodiments, the steering input unit 721A may be configured as a touchscreen, a touch pad, or a button.

The shift input unit 721D is configured to receive input for selecting one of Park (P), Drive (D), Neutral (N), and Reverse (R) gears of the vehicle from the user. The shift input unit 721D may have a lever form. In some embodiments, the shift input unit 721D may be configured as a touchscreen, a touch pad, or a button.

The acceleration input unit 721C is configured to receive input for acceleration of the vehicle from the user. The brake input unit 721B is configured to receive input for speed reduction of the vehicle from the user. Each of the acceleration input unit 721C and the brake input unit 721B may have a pedal form. In some embodiments, the acceleration input unit 721C or the brake input unit 721B may be configured as a touchscreen, a touch pad, or a button.

The camera 722 may include an image sensor and an image processing module. The camera 722 may process a still image or a moving image obtained by the image sensor (e.g., a CMOS or a CCD). The image processing module may process the still image or the moving image acquired through the image sensor, extract information and deliver the extracted information to the controller 770.

The vehicle may include the camera 722 for capturing the front image of the vehicle or the image of the vicinity of the vehicle and the interior camera 160 for capturing the interior image of the vehicle.

The interior camera 160 may acquire the image of the passenger. The interior camera 160 may acquire a biometric image of the passenger.

The microphone 723 may process an external sound signal into electrical data. The processed data may be variously used according to the function of the vehicle. The microphone 723 may convert a user voice command into electrical data. The converted electrical data may be delivered to the controller 770.

In some embodiments, the camera 722 or the microphone 723 may not be included in the input unit 720 but may be included in the sensing unit 760.

The user input unit 724 is configured to receive information from the user. When information is input via the user input unit 724, the controller 770 may control the operation of the vehicle to correspond to the input information. The user input unit 724 may include a touch input unit or a mechanical input unit. In some embodiments, the user input unit 724 may be located in a region of the steering wheel. In this case, the driver may operate the user input unit 724 with the fingers while gripping the steering wheel.

The sensing unit 760 is configured to sense signals associated with, for example, signals related to driving of the vehicle. To this end, the sensing unit 760 may include a collision sensor, a wheel sensor, a speed sensor, tilt sensor, a weight sensor, a heading sensor, a yaw sensor, a gyro sensor, a position module, a vehicle forward/reverse sensor, a battery sensor, a fuel sensor, a tire sensor, a steering sensor based on rotation of the steering wheel, a vehicle interior temperature sensor, a vehicle interior humidity sensor, an ultrasonic sensor, a radar, a Lidar, etc.

As such, the sensing unit 760 may acquire sensing signals with regard to, for example, vehicle collision information, vehicle traveling direction information, vehicle location information (GPS information), vehicle angle information, vehicle speed information, vehicle acceleration information, vehicle tilt information, vehicle forward/reverse information, battery information, fuel information, tire information, vehicle lamp information, vehicle interior temperature information, vehicle interior humidity information, steering wheel rotation angle information, etc.

Meanwhile, the sensing unit 760 may further include, for example, an accelerator pedal sensor, a pressure sensor, an engine speed sensor, an Air Flow-rate Sensor (AFS), an Air Temperature Sensor (ATS), a Water Temperature Sensor (WTS), a Throttle Position Sensor (TPS), a Top Dead Center (TDC) sensor, and a Crank Angle Sensor (CAS).

The sensing unit 760 may include a biometric sensor. The biometric sensor senses and acquires biometric information of the passenger. The biometric information may include fingerprint information, iris-scan information, retina-scan information, hand geometry information, facial recognition information, and voice recognition information. The biometric sensor may include a sensor for sensing biometric information of the passenger. Here, the monitoring unit 725 and the microphone 723 may operate as a sensor. The biometric sensor may acquire hand geometry information and facial recognition information through the monitoring unit 725.

The output unit 740 is configured to output information processed by the controller 770. The output unit 740 may include a display unit 741, a sound output unit 742, and a haptic output unit 743.

The display unit 741 may display information processed by the controller 770. For example, the display unit 741 may display vehicle associated information. Here, the vehicle associated information may include vehicle control information for direct control of the vehicle or driver assistance information for aiding in driving of the vehicle. In addition, the vehicle associated information may include vehicle state information that indicates the current state of the vehicle or vehicle traveling information regarding traveling of the vehicle.

The display unit 741 may include at least one selected from among a Liquid Crystal Display (LCD), a Thin Film Transistor LCD (TFT LCD), an Organic Light Emitting Diode (OLED), a flexible display, a 3D display, and an e-ink display.

The display unit 741 may configure an inter-layer structure with a touch sensor, or may be integrally formed with the touch sensor to implement a touchscreen. The touchscreen may function as the user input unit 724 which provides an input interface between the vehicle and the user and also function to provide an output interface between the vehicle and the user. In this case, the display unit 741 may include a touch sensor which senses a touch to the display unit 741 so as to receive a control command in a touch manner. When a touch is input to the display unit 741 as described above, the touch sensor may sense the touch and the controller 770 may generate a control command corresponding to the touch. Content input in a touch manner may be characters or numbers, or may be, for example, instructions in various modes or menu items that may be designated.

Meanwhile, the display unit 741 may include a cluster to allow the driver to check vehicle state information or vehicle traveling information while driving the vehicle. The cluster may be located on a dashboard. In this case, the driver may check information displayed on the cluster while looking forward.

Meanwhile, in some embodiments, the display unit 741 may be implemented as a head up display (HUD). When the display unit 741 is implemented as a HUD, information may be output via a transparent display provided at the windshield. Alternatively, the display unit 741 may include a projector module to output information via an image projected onto the windshield.

The sound output unit 742 is configured to convert electrical signals from the controller 170 into audio signals and to output the audio signals. To this end, the sound output unit 742 may include, for example, a speaker. The sound output unit 742 may output sound corresponding to the operation of the user input unit 724.

The haptic output unit 743 is configured to generate tactile output. For example, the haptic output unit 743 may operate to vibrate a steering wheel, a safety belt, or a seat so as to allow the user to recognize an output thereof.

The vehicle drive unit 750 may control the operation of various devices of the vehicle. The vehicle drive unit 750 may include at least one of a power source drive unit 751, a steering drive unit 752, a brake drive unit 753, a lamp drive unit 754, an air conditioner drive unit 755, a window drive unit 756, an airbag drive unit 757, a sunroof drive unit 758, and a suspension drive unit 759.

The power source drive unit 751 may perform electronic control of a power source inside the vehicle.

For example, in the case where a fossil fuel based engine (not illustrated) is a power source, the power source drive unit 751 may perform electronic control of the engine. As such, the power source drive unit 751 may control, for example, an output torque of the engine. In the case where the power source drive unit 751 is an engine, the power source drive unit 751 may control the speed of the vehicle by controlling the output torque of the engine under the control of the controller 770.

In another example, in the case where an electric motor (not illustrated) is a power source, the power source drive unit 751 may perform control of the motor. As such, the power source drive unit 751 may control, for example, the RPM and torque of the motor.

The steering drive unit 752 may perform electronic control of a steering apparatus inside the vehicle. The steering drive unit 752 may change the direction of travel of the vehicle.

The brake drive unit 753 may perform electronic control of a brake apparatus (not illustrated) inside the vehicle. For example, the brake drive unit 753 may reduce the speed of the vehicle by controlling the operation of brakes located at wheels. In another example, the brake drive unit 753 may adjust the direction of travel of the vehicle leftward or rightward by differentiating the operation of respective brakes located at left and right wheels.

The lamp drive unit 754 may turn at least one lamp arranged inside and outside the vehicle on or off. In addition, the lamp drive unit 754 may control, for example, the intensity and direction of light of each lamp. For example, the lamp drive unit 754 may perform control of a turn signal lamp or a brake lamp.

The air conditioner drive unit 755 may perform electronic control of an air conditioner (not illustrated) inside the vehicle. For example, when the interior temperature of the vehicle is high, the air conditioner drive unit 755 may operate the air conditioner to supply cold air to the interior of the vehicle.

The window drive unit 756 may perform electronic control of a window apparatus inside the vehicle. For example, the window drive unit 756 may control opening or closing of left and right windows of the vehicle.

The airbag drive unit 757 may perform the electronic control of an airbag apparatus inside the vehicle. For example, the airbag drive unit 757 may control an airbag to be deployed in a dangerous situation.

The sunroof drive unit 758 may perform electronic control of a sunroof apparatus (not illustrated) inside the vehicle. For example, the sunroof drive unit 758 may control opening or closing of a sunroof.

The suspension drive unit 759 may perform electronic control of a suspension apparatus (not shown) inside the vehicle. For example, when a road surface is uneven, the suspension drive unit 759 may control the suspension apparatus to reduce vibrations of the vehicle.

The memory 730 is electrically connected to the controller 770. The memory 730 may store basic data of the unit, control data for operation control of the unit and input/output data. The memory 730 may be various storage apparatuses, which are implemented in a hardware manner, such as a ROM, RAM, EPROM, flash drive and hard drive. The memory 730 may store a variety of data for overall operation of the vehicle, such as a program for processing or control of the controller 770.

The interface 780 may serve as a passage for various kinds of external devices that are connected to the vehicle. For example, the interface 780 may have a port that is connectable to the mobile terminal 600 and may be connected to the mobile terminal 600 via the port. In this case, the interface 780 may exchange data with the mobile terminal 600.

The interface 780 may serve as a passage for providing electric energy to the connected mobile terminal 600. When the mobile terminal 600 is electrically connected to the interface 780, the interface 780 may provide electric energy supplied from the power supply unit 790 to the mobile terminal 600 under control of the controller 770.

The controller 770 may control the overall operation of each unit inside the vehicle. The controller 770 may be referred to as an Electronic Control Unit (ECU).

The controller 770 may perform a function corresponding to the delivered signal according to delivery of a signal for executing the interior camera 160.

The controller 770 may be implemented in a hardware manner using at least one selected from among Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, and electric units for the implementation of other functions.

The controller 770 may perform the role of the above-described processor 170. That is, the processor 170 of the interior camera 160 may be directly set in the controller 770 of the vehicle. In such an embodiment, the interior camera 160 may be understood as a combination of some components of the vehicle.

Alternatively, the controller 770 may control the components to transmit information requested by the processor 170.

The power supply unit 790 may supply power to operate the respective components under the control of the controller 770. In particular, the power supply unit 790 may receive power from, for example, a battery (not illustrated) inside the vehicle.

The AVN apparatus 400 may exchange data with the controller 770. The controller 770 may receive navigation information from the AVN apparatus or a separate navigation apparatus. Here, the navigation information may include destination information, information on a route to the destination, map information related to vehicle traveling and current position information of the vehicle.

The above described features, configurations, effects, and the like are included in at least one of the embodiments of the present invention, and are not limited to only one embodiment. In addition, the features, configurations, effects, and the like as illustrated in each embodiment may be implemented with regard to other embodiments as they are combined with one another or modified by those skilled in the art. Thus, content related to these combinations and modifications include in the scope and spirit of the invention as disclosed in the accompanying claims.

Further, although the embodiments have been mainly described until now, they are just exemplary and do not limit the present invention. Thus, those skilled in the art to which the present invention pertains will know that various modifications and applications which have not been exemplified may be carried out within a range which does not deviate from the essential characteristics of the embodiments. For instance, the constituent elements described in detail in the exemplary embodiments can be modified to be carried out. Further, the differences related to such modifications and applications shall be construed to be included in the scope of the present invention specified in the attached claims.

What is claimed is:

1. An interior camera apparatus comprising:
a frame body;
a stereo camera provided in the frame body and comprising a first camera and a second camera;
a light module provided in the frame body and configured to radiate infrared light; and
a circuit board connected to the stereo camera and the light module,
wherein the light module comprises a first light emitting element and a second light emitting element, the interior camera apparatus configured to direct infrared light emitted from the first light emitting element in a first irradiation direction and to direct infrared light emitted from the second light emitting element in a second irradiation direction different from the first irradiation direction.

2. The interior camera apparatus according to claim 1, wherein:
the frame body defines a first hole in which the first camera is provided, a second hole in which the light module is provided, and a third hole in which the second camera is provided, and
the first hole, the second hole, and the third hole are arranged along a common direction.

3. The interior camera apparatus according to claim 1, wherein:
the first light emitting element comprises a first light emitting chip and a first substrate supporting the first light emitting chip,
the second light emitting element comprises a second light emitting chip and a second substrate supporting the second light emitting chip,
an upper surface of the first substrate is aligned in the first irradiation direction, and
an upper surface of the second substrate is aligned in the second irradiation direction.

4. The interior camera apparatus according to claim 1, further comprising:
a first optical member provided on the first light emitting element and configured to distribute infrared light radiated by the first light emitting element in the first irradiation direction; and
a second optical member provided on the second light emitting element and configured to distribute infrared light radiated by the second light emitting element in the second irradiation direction.

5. The interior camera apparatus according to claim 1, wherein:
the first light emitting element comprises a first light emitting chip and a first body that surrounds the first light emitting chip and that is configured to guide infrared light radiated by the first light emitting chip in the first irradiation direction, and
the second light emitting element comprises a second light emitting chip and a second body that surrounds the second light emitting chip and that is configured to guide infrared light radiated by the second light emitting chip in the second irradiation direction.

6. The interior camera apparatus according to claim 1, wherein:
the frame body is a first frame body, the stereo camera is a first stereo camera, the light module is a first light module, and the circuit board is a first circuit board, and
the interior camera apparatus further comprises a second frame body, a second stereo camera, a second light module, and a second circuit board,
the interior camera apparatus further comprising:
a first interior camera module comprising the first frame body, the first stereo camera, the first light module, and the first circuit board;
a second interior camera module comprising the second frame body, the second stereo camera, the second light module, and the second circuit board; and
a frame cover configured to support the first interior camera module and second interior camera module.

7. The interior camera apparatus according to claim 6, wherein the frame cover defines:
a first cavity configured to accommodate the first interior camera module; and
a second cavity configured to accommodate the second interior camera module, and
wherein the frame cover comprises a bridge base configured to connect the first cavity and the second cavity.

8. The interior camera apparatus according to claim 7, wherein:
the frame cover comprises a first surface that defines the first cavity, the first surface further defining a first cover hole, a second cover hole, and a third cover hole, and
the frame cover comprises a second surface that defines the second cavity, the second surface further defining a fourth cover hole, a fifth cover hole, and a sixth cover hole.

9. The interior camera apparatus according to claim 8, wherein the first surface and the second surface of the frame cover are symmetrical to each other around a reference line traversing the bridge base of the frame cover.

10. The interior camera apparatus according to claim 1, further comprising at least one processor provided on the circuit board and configured to control the stereo camera and the light module.

11. The interior camera apparatus according to claim 10, wherein the at least one processor is configured to selectively drive the first light emitting element and the second light emitting element.

12. The interior camera apparatus according to claim 11, wherein the at least one processor is further configured to sequentially and repeatedly perform:
a first control process of controlling the first light emitting element to be in an on state and controlling the second light emitting element to be in an off state,
a second control process of controlling the first light emitting element to be in an off state and controlling the second light emitting element to be in an on state, and
a third control process of controlling both the first light emitting element and the second light emitting element to be in an off state.

13. The interior camera apparatus according to claim 12, wherein:
the stereo camera comprises a rolling shutter type camera and is configured to sense an image, and
the at least one processor is configured to perform the first control process of controlling the first light emitting element to be in the on state and controlling the second light emitting element to be in the off state in coordination with an exposure time of the stereo camera.

14. The interior camera apparatus according to claim 13, wherein the at least one processor is further configured to, during the first control process:
control the stereo camera to sense, during the first control period, an image on a first pixel area of the stereo camera matching the first irradiation direction in which the infrared light is emitted from the first light emitting element of the light module.

15. The interior camera apparatus according to claim 14, wherein the at least one processor is further configured to:
perform the second control process of controlling the first light emitting element to be in the off state and controlling the second light emitting element to be in the on state an based on completion of sensing the image on the first pixel area being completed, and
control the stereo camera to sense, during the second control process, the image on a second pixel area matching the second irradiation direction in which the infrared light is emitted from the second light emitting element of the light module.

16. The interior camera apparatus according to claim 15, wherein the at least one processor is further configured to perform the third control process of controlling both the first light emitting element and the second light emitting element to be in the off state based on completion of sensing the image on the first pixel area and the second pixel area.

17. The interior camera apparatus according to claim 13, wherein the stereo camera and the light module are configured such that an image-sensing direction of the stereo camera corresponds to an infrared-light irradiation direction of the light module.

18. The interior camera apparatus according to claim 17, wherein the stereo camera and the light module are configured such that a change in the image sensing direction of the stereo camera matches a change in the infrared-light irradiation direction of the light module.

19. A driver assistance apparatus configured to:
monitor, by the interior camera apparatus according to claim 1, a user entering a vehicle;
acquire monitoring information based on monitoring the user entering the vehicle; and
control a driver assistance function based on the monitoring information.

20. A vehicle comprising the interior camera apparatus according to claim 1, wherein the interior camera apparatus is provided on a ceiling of the vehicle.
